(19) United States
(12) Patent Application Publication
(10) Pub. No.: US 2018/0234295 A1
(43) Pub. Date: Aug. 16, 2018

(54) COMMUNICATION SYSTEM, INFORMATION PROCESSING APPARATUS, AND METHOD FOR COMMUNICATION

(71) Applicants: Takeshi KOYAMA, Saitama (JP); Kiyoshi KASATANI, Kanagawa (JP); Yoshiko AONO, Kanagawa (JP)

(72) Inventors: Takeshi KOYAMA, Saitama (JP); Kiyoshi KASATANI, Kanagawa (JP); Yoshiko AONO, Kanagawa (JP)

(73) Assignee: Ricoh Company, Ltd., Tokyo (JP)

(21) Appl. No.: 15/750,857

(22) PCT Filed: Sep. 27, 2016
(86) PCT No.: PCT/JP2016/004358

§ 371 Date: Feb. 7, 2018

(30) Foreign Application Priority Data
Sep. 30, 2015 (JP) 2015-194990

(51) Int. Cl. H04L 12/24; G06F 17/30

(52) U.S. Cl. CPC H04L 41/0846; G06F 17/30327

(57) ABSTRACT

[Object] To provide an information processing apparatus capable of synchronizing setting information with another information processing apparatus. [Means of Achieving the Object] A communication system (1) including information processing apparatuses forming a hierarchic structure having a depth of three or more levels. At least one of the information processing apparatuses arranged in any level situated lower in the hierarchic structure than at least one of the information processing apparatuses which receives setting information entered to the at least one of the information processing apparatuses includes a communication information storing unit (5002) configured to store communication information for communicating with one of the information processing apparatuses arranged in a level immediately above, and an acquiring unit (186) configured to acquire the setting information through communication with the one of the information processing apparatuses in the level immediately above by use of the communication information retrieved from the communication information storing unit (5002) and configured to store the acquired setting information in a setting information storing unit (2001, 5001). The at least one of the information processing apparatuses arranged in any level situated lower in the hierarchic structure than the at least one of the information processing apparatuses which receives the entered setting information performs processing of acquiring the setting information stored in the setting information storing unit (2001, 5001) provided on the one of the information processing apparatuses arranged in the level immediately above.

### TECHNICAL FIELD

The present disclosure relates to communication systems, information processing apparatuses, and methods for communication.

### BACKGROUND ART

An electronic blackboard provided with a touch panel on a large-size flat panel display is known in the art. Such an electronic blackboard displays a screen used as a blackboard, on which trajectories of an electronic pen or a finger are input through the touch panel, and then display the trajectories on the screen as handwriting information. In such a way, the screen is used just as a blackboard. Furthermore, an electronic blackboard which is connectable to a personal computer may display the same screen as the personal computer, so as to superimpose handwritten information on the screen and to operate the personal computer according to information input through the touch panel.

Furthermore, an administrator may perform settings relating to, for example, security on such an electronic blackboard.

Conventionally, techniques for performing the same setting on multiple apparatuses in efficient ways have been invented (see, for example, Patent Document 1). Patent Document 1 discloses a network synchronization system including multiple information processing devices. A first information processing device includes a synchronization-use common storage unit configured to copy and store personal setting information for each user. A second information processing device includes a setting information unit configured to store personal setting information for each user, and a synchronization control unit configured to update the personal information for each user stored in the setting information unit to latest personal setting information for each user. The synchronization control unit acquires update information common to the multiple information processing devices, which is stored in the synchronization-use common storage unit.

### CITATION LIST

### Patent Literature

PTL 1: Japanese Patent No. 4942686

### SUMMARY OF INVENTION

### Technical Problem

However, such a network synchronization system as disclosed in Patent Document 1 has difficulty synchronizing a large number of electric blackboards. For example, in a case of having a number of first apparatuses, the second apparatus need synchronize all of the first apparatuses, which causes a heavy load.

In view of the above technical problem, the objective of the present invention is to provide an information processing apparatus capable of synchronizing setting information with another information processing apparatus.

### Solution to Problem

One aspect of the present invention provides a communication system including information processing apparatuses forming a hierarchic structure having a depth of three or more levels. Each of the information processing apparatuses includes a setting information storing unit configured to store setting information relating to respective operations. At least one of the information processing apparatuses includes a setting receiving unit configured to receive setting information entered to the at least one of the information processing apparatuses and configured to store the setting information in the setting information storing unit. At least one of the information processing apparatuses arranged in any level situated lower in the hierarchic structure than the at least one of the information processing apparatuses which receives the entered setting information includes a communication information storing unit configured to store communication information for communicating with one of the information processing apparatuses arranged in a level immediately above, and an acquiring unit configured to acquire the setting information through communication with the one of the information processing apparatuses in the level immediately above by use of the communication information retrieved from the communication information storing unit and configured to store the acquired setting information in the setting information storing unit. At least one of the information processing apparatuses arranged in any level situated lower in the hierarchic structure than the at least one of the information processing apparatuses which receives the entered setting information performs processing of acquiring the setting information stored in the setting information storing unit provided on the one of the information processing apparatuses arranged in the level immediately above.

### Advantageous Effects of Invention

An information processing apparatus capable of synchronizing setting information with another information processing apparatus is provided.

### BRIEF DESCRIPTION OF DRAWINGS

FIG. 1A is a drawing illustrating a comparative example of a network configuration for setting information;

FIG. 1B is a drawing illustrating a comparative example of the network configuration for setting information;

FIG. 2 is a drawing illustrating an example the synchronization method in an image processing system;

FIG. 3 is a drawing illustrating an example of a general arrangement of the image processing system;

FIG. 4 is a drawing illustrating an example of a hardware configuration of an electronic blackboard;

FIG. 5 is a functional block diagram of the electronic blackboard;

FIG. 6 is a functional block diagram of a file processor;

FIG. 7 is a functional block diagram of a server unit and a client unit;

FIG. 8 is a drawing illustrating a configuration of each of the image layers;

FIG. 9 is a drawing illustrating a processing sequence of the electronic blackboard;

FIG. 10 is a drawing illustrating a processing sequence of the electronic blackboard;

FIG. 11A is a drawing illustrating an example of the network configuration of the image processing system;

FIG. 11B is a drawing illustrating an example of functions operated on each of the electronic blackboards at the time of performing setting of setting information;

FIG. 12 is a drawing illustrating an example of a hardware configuration of a setting administrative PC;

FIG. 13 is a functional block diagram illustrating examples of the setting acquirer and the setting provider in detail;

FIG. 14A is a drawing illustrating an example of a setting information setting screen;

FIG. 14B is a drawing illustrating an example of a communication information setting screen;

FIG. 15 is a sequence diagram illustrating a sequence performed in the image processing system for synchronizing setting information;

FIG. 16 is a flowchart illustrating an example of a sequence performed by an electronic blackboard in a lower level for updating setting information;

FIG. 17A is a drawing illustrating an example of the setting information setting screen;

FIG. 17B is a drawing illustrating an example of an error code displayed on a display of the electronic blackboard;

FIG. 18 is a drawing for schematically explaining synchronization of setting information in the image processing system (second embodiment);

FIG. 19 is a functional block diagram illustrating examples of a setting provider and a setting acquirer (second embodiment);

FIG. 20 is a sequence diagram illustrating an example of a sequence of synchronization of setting information performed in the image processing system (second embodiment); and

FIG. 21 is a flowchart illustrating processing performed by each of the electronic blackboards, responding to a detection of an update of setting information.

### DESCRIPTION OF EMBODIMENTS

In the following, embodiments of the present invention will be described with reference to accompanying drawings.

<Comparison to the Background Art>

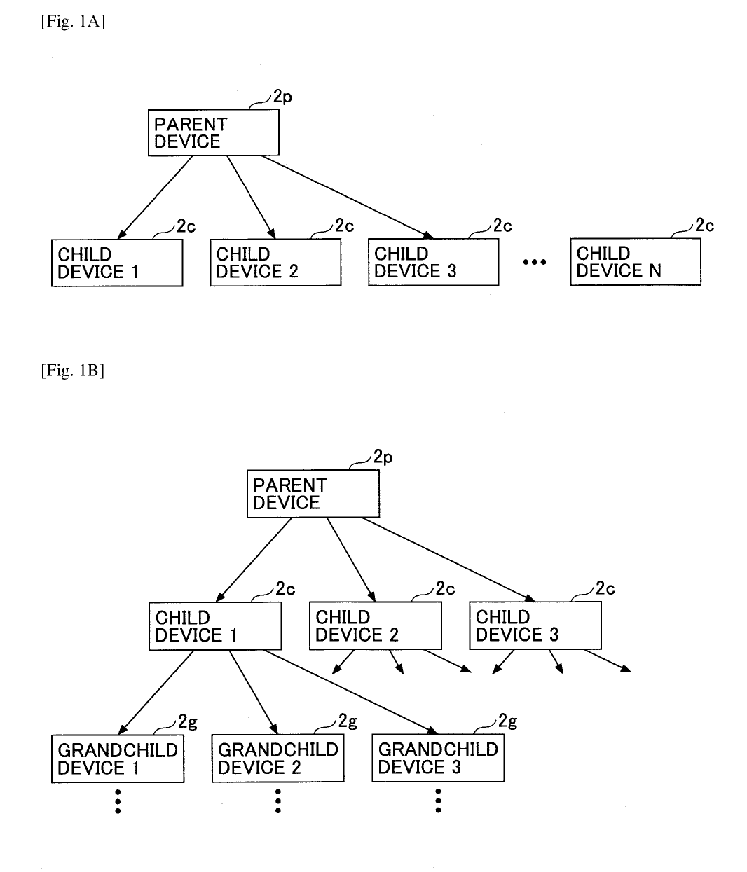

Before describing an image processing system according the embodiments of the present invention, a comparative example of synchronization processing of setting information will be described. FIGS. 1A and 1B are drawings illustrating comparative examples of network configurations for performing setting of setting information. In FIG. 1A, one electronic blackboard 2 serves as a parent device 2p and the other electronic blackboards 2 serve as child devices 2c (also referred to as child devices 1 through N when differentiated), which constitute a network configuration in which the parent device 2p is coupled to each of the child devices 1 through N. Here, when the parent device performs setting of setting information on the other child devices 1 through N, a heavy load is expected to be imposed on the parent device 2p.

Alternatively, as illustrated in FIG. 1B, the parent device 2p may be provided with fewer than a predetermined number (three, in the drawing) of child devices 2c on which the parent device 2p performs setting of setting information. In FIG. 1B, the parent device 2p performs setting of setting information on the child devices 1 through 3, and the child device 1 performs setting of the setting information on grandchild devices 2g (also referred to as grandchild devices 1 through 3 when differentiated). In such a configuration, the load on the parent device 2p is reduced. Nevertheless, a heavy load is still imposed on each of the electronic blackboards 2, considering that the parent device 2p performs setting of the setting information on the child devices 1 through 3, and the child device 1 performs setting of the setting information on grandchild devices 1 through 3.

Additionally, in a daisy chain configuration, for example, where a parent device and a child device as well as a child device and a grandchild device perform one-on-one communication, a single electronic blackboard 2 performs setting of setting information on only another single electronic blackboard 2. However, such a configuration may cause another problem that it takes too much time until the setting of the setting information is performed on the last electronic blackboard 2.

<<Summary of a Synchronization Method According to the Embodiments>>

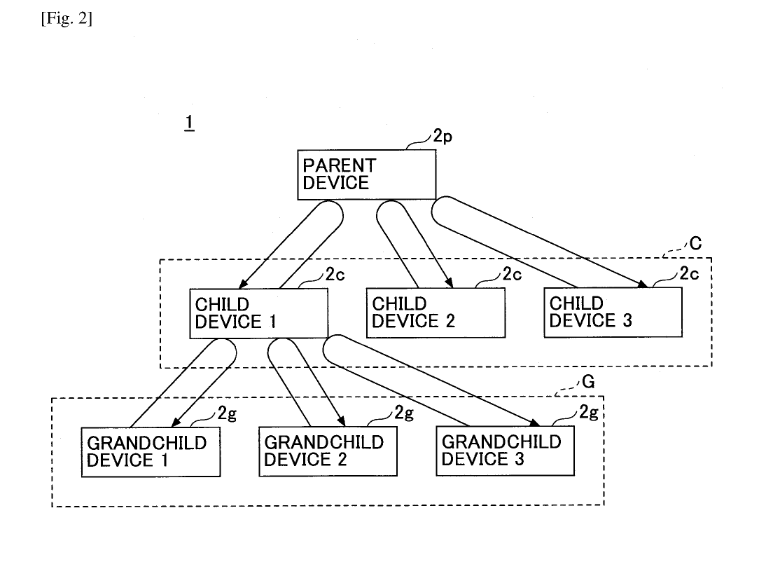

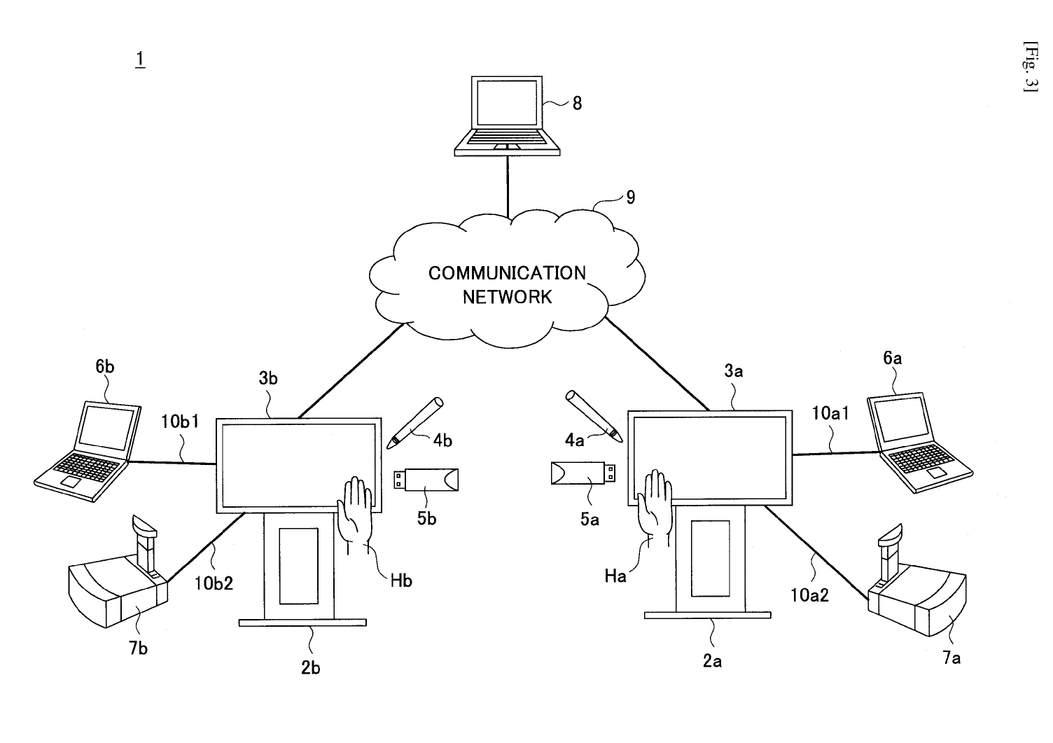

FIG. 2 is a drawing illustrating an example of a synchronization method implemented in the image processing system 1 according to the embodiments. The image processing system 1 has a tree network configuration, that is to say, a hierarchic structure with multiple electronic blackboards 2 arranged in multiple levels. The tree configuration is a type of hierarchic structures, in which each node (i.e. electronic blackboard 2) branches into other nodes (i.e. electronic blackboards 2).

According to the embodiments of the present invention, instead of setting setting information from the parent device 2p to the child devices 2c or from the child devices 2c to the grandchild devices 2g, the child device 1 performs communication with the parent device 2p so as to acquire the setting information from the parent device 2p, and then applies the setting. So do the child devices 2 and 3. Similarly, the grandchild device 1 performs communication with the child device 1 so as to acquire the setting information from the child device 1, and then applies the setting. So do the grandchild devices 2 and 3.

Using such a synchronization method, the load imposed on each of the electronic blackboards 2 associated with performing setting of setting information is reduced, as each of the electronic blackboards 2 communicate with only a single electronic blackboard 2 arranged in a level immediately above itself for acquiring the setting information. Further, each of the electronic blackboards 2 need not have information with regard to updates of setting information performed on an electronic blackboard 2 arranged in a level immediately below itself. Moreover, as each of the electronic blackboards 2 only needs to transmit setting information in response to a request from each of the electronic blackboards 2 arranged in a level immediately below itself, a load for processing is relatively small, which enables each of the electronic blackboards 2 to have multiple (three, in the drawing) information processing apparatuses in a level immediately below itself. In such a way, synchronization of setting information on all of the electronic blackboards 2 is possible with relatively small loads and with reduced time difference between setting of the setting information on the parent device 2p and setting of the setting information on the grandchild devices 2g and descendent electronic blackboards 2.

As illustrated in the drawing, the tree network configuration is constituted with at least three levels. Here, as long as the deepest level is the third or deeper level, there may be branches that end in the second level. Further, the number of the electronic blackboards 2 arranged in a level is not limited to three, and may be determined in consideration of the total number of the electronic blackboards 2 and the depth of the tree network configuration.

In the following, as a matter of convenience in explanation, the level in which the child devices 1 through 3 are arranged is referred to as a child device level C and the level in which the grandchild devices 1 through 3 are arranged is referred to as a grandchild device level G. Furthermore, without differentiating the parent device 2p and the child device level C or the child device level C and the grandchild device level D, each of the electronic blackboards 2 arranged in a level relatively above another electronic blackboard 2 (in a relationship of being immediately above the other electronic blackboard 2, such as the parent device 2p viewed from the child device 1) may be referred to an electronic blackboard 2 in a higher level, whereas each of the electronic blackboards 2 arranged in a level relatively below another electronic blackboard 2 (in a relationship of being immediately below the other electronic blackboard 2, such as the child device 1 viewed from the parent device 2p) may be referred to an electronic blackboard 2 in a lower level.

<System Configuration>

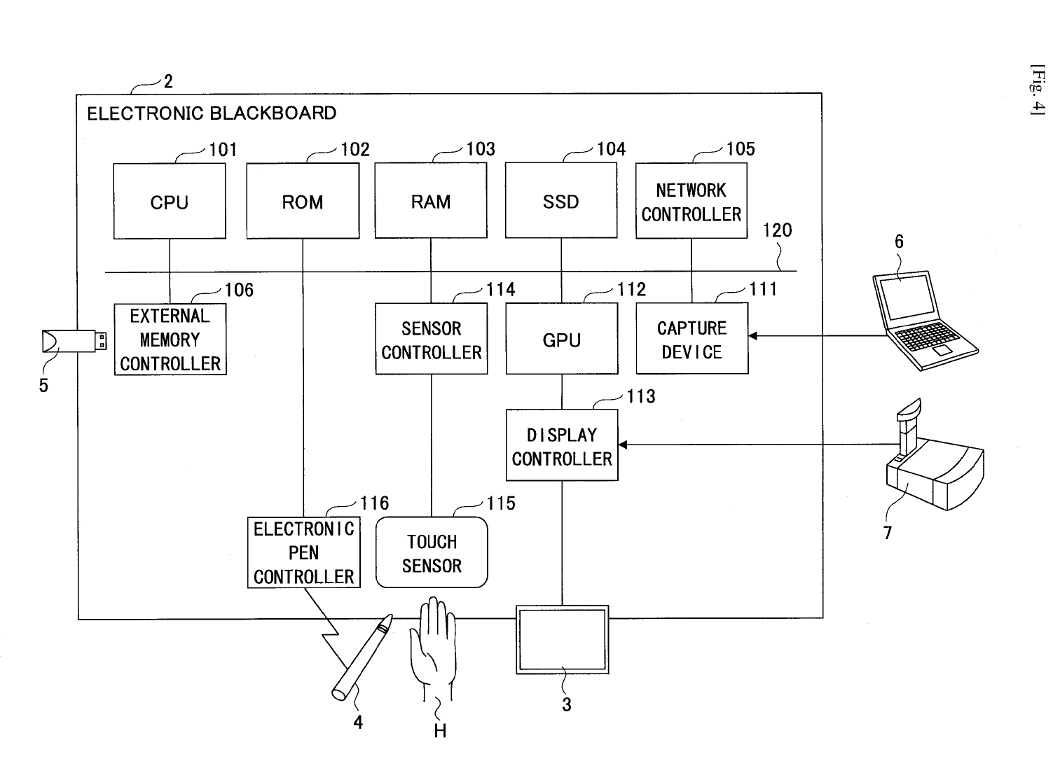

FIG. 3 is a drawing illustrating an example of a general arrangement of an image processing system 1 according to embodiments of the present invention. Here in FIG. 3, two electronic blackboards 2a and 2b along with accompanying electronic pens 4a and 4b, etc., are illustrated for ease of explanation. However, the image processing system 1 may include three or more electronic blackboards, electronic pens, etc.

As illustrated in FIG. 3, the image processing system 1 includes the electronic blackboards 2a and 2b, the electronic pens 4a and 4b, universal serial bus (USB) memories 5a and 5b, laptop computers 6a and 6b, teleconference (video conference) terminals 7a and 7b, and a personal computer (PC) 8. Here, the electronic blackboards 2a and 2b and the PC 8 are interconnected via a communication network 9. Furthermore, the electronic blackboards 2a and 2b are provided with displays 3a and 3b, respectively.

The electronic blackboard 2a is capable of displaying on the display 3a an image which is drawn through an event generated by the electronic pen 4a (e.g. touching the display 3 with the pen tip or pen end of the electronic pen 4a). In addition to the electronic pen 4a, the electronic blackboard 2a is capable of changing an image displayed on the display 3a based on an event generated by a hand Ha of a user (e.g. gesture such as enlarging/reducing the size of an image and turning a page).

Furthermore, the USB memory 5a may be connected to the electronic blackboard 2a, so that the electronic blackboard 2a performs read and write processing of an electronic file such as a PDF file to the USB memory 5a. Further, the laptop computer 6a is connected to the electronic blackboard 2a via a cable 10al that enables communication according to a standard such as Display Port (registered trademark), Digital Visual Interface (DVI), High-Definition Multimedia Interface (HDMI; registered trademark), and Video Graphics Array (VGA). Here, responding to an event generated through touching the display 3a, the electronic blackboard 2a transmits event information indicative of the event to the laptop computer 6a, just as events generated through an input device such as a mouse and a keyboard. Similarly, teleconference terminal 7a is connected to the electronic blackboard 2a via a cable 10a2 that enables communication according to such a standard as mentioned above. Here, the laptop computer 6a and the teleconference terminal 7a may perform wireless communication with the electronic blackboard 2a according to a wireless communication protocol such as Bluetooth (registered trademark).

In the meantime, at another location provided with the electronic blackboard 2b, the electronic blackboard 2b including the display 3b, the electronic pen 4b, the USB memory 5b, the laptop computer 6b, the teleconference terminal 7b, a cable 10b1, and a cable 10b2 are similarly employed in such a manner as described above. Further, the electronic blackboard 2a is capable of changing an image displayed on the display 3b may be changed based on an event generated by a hand Hb of a user.

In such a way, an image drawn on the display 3a of the electronic blackboard 2a at one of the locations is displayed on the display 3b of the electronic blackboard 2b at another location, whereas an image drawn on the display 3b of the electronic blackboard 2b at one of the locations is displayed on the display 3a of the electronic blackboard 2a at another location. Here, the image processing system 1 enables remote-sharing processing for sharing the same image at remote locations, and therefore is conveniently used when a conference at remote locations is held.

Here, in the following description, an unspecified electronic blackboard among multiple electronic blackboards is referred to as an electronic blackboard 2. An unspecified display among multiple displays is referred to as a display 3. An unspecified electronic pen among multiple electronic pens is referred to as an electronic pen 4. An unspecified USB among multiple USBs is referred to as a USB memory 5. An unspecified laptop computer among multiple laptop computers is referred to as a laptop computer 6. An unspecified teleconference terminal among multiple teleconference terminals is referred to as a teleconference terminal 7. An unspecified hand among multiple hands is referred to as a hand H. An unspecified cable among multiple cables is referred to as a cable 10.

Further, although the electronic blackboard 2 is described as an example of an information processing apparatus in the embodiments, the information processing apparatus of the present invention is not limited to an electronic blackboard. Another example of the information processing apparatus is an electronic signboard (digital signage), a telestrator used in sports and weather broadcasts, a remote image (video) diagnostic apparatus, etc. Further, although the laptop computer 6 is described as an example of an information processing terminal, the information processing terminal of the present invention is not limited to a laptop computer. Another example of the information processing terminal is a desktop PC, a tablet PC, a personal digital assistant (PDA), a digital video camera, a digital camera, a game machine, and other types of terminals that are capable of rendering an image frame. Further, the communication network 9 may be the Internet, a Local Area Network (LAN), a mobile telephone network, etc. d. Further, although the USB memory 5 is described as an example of a recording medium in the embodiments, the recording medium of the present invention is not limited to a USB memory. Another example of the recording medium is a secure digital (SD) card, etc.

<Hardware Configuration of Electronic Blackboard>

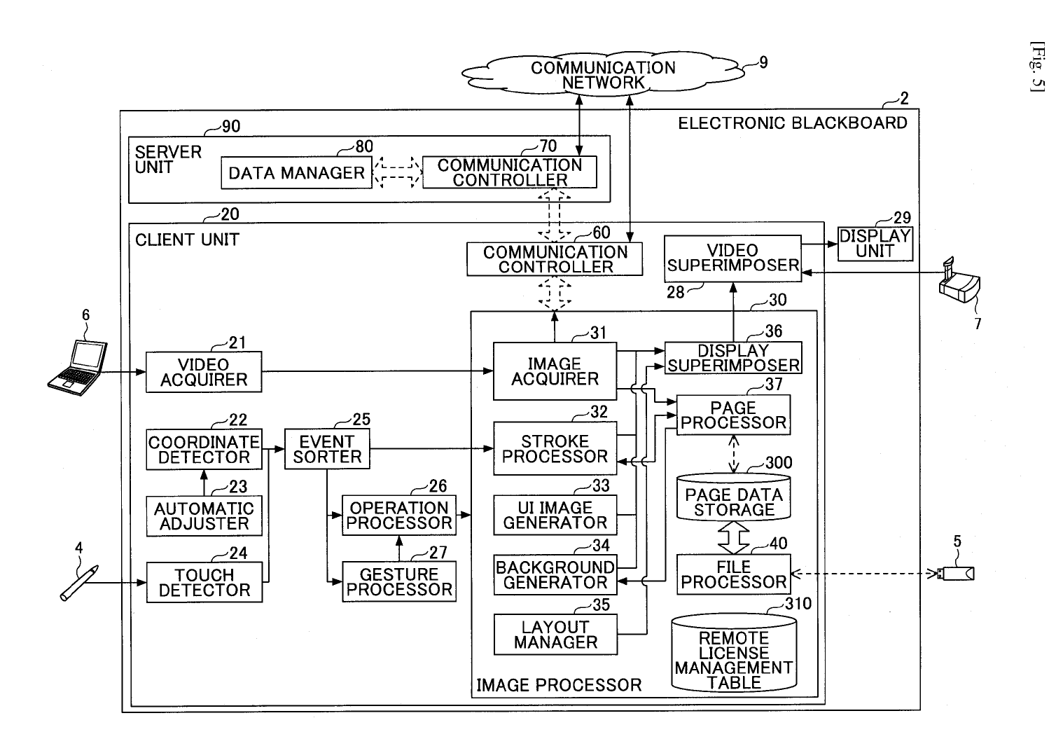

In the following, a hardware configuration of the electronic blackboard 2 according to the present embodiment is described with reference to FIG. 4. FIG. 4 is a drawing illustrating an example of a hardware configuration of the electronic blackboard 2.

As illustrated in FIG. 4, the electronic blackboard 2 includes a central processing unit (CPU) 101 that controls overall operations of the electronic blackboard 2, a read-only memory (ROM) 102 that stores programs such as an initial program loader (IPL) used for activating the CPU 101, a random access memory (RAM) 103 that is used as a work area of the CPU 101, a solid state drive (SSD) 104 that stores various data such as programs used for the electronic blackboard 2, a network controller 105 that controls communication with the communication network 9, and an external memory controller 106 that controls communication with the USB memory 5.

The electronic blackboard 2 further includes a capture device 111 that displays video information on a display of the laptop computer 6 in a form of a still image or a moving image, a graphics processing unit (GPU) 112 dedicated to processing graphics, and a display controller 113 that controls and manages screen display operations for displaying an output image from the GPU on the display 3 or the teleconference terminal 7.

The electronic blackboard 2 further includes a touch sensor 115 that detects being touched by the electronic pen 4 or the hand H of the user on the display 3, and a sensor controller 114 that controls processing of the touch sensor 115. The touch sensor 115 performs an input and a detection of a coordinate in an infrared ray insulating method. In the method for inputting and detecting coordinates, two light-emitting/receiving units provided on respective ends of the upper side of the display 3 emit multiple infrared rays parallel to the surface of the display 3. Emitted lights are reflected by the reflection members surrounding the display 3 and track back the same paths to return to the light-emitting/receiving units, and then are received by light-receiving elements. The touch sensor 115 outputs to the sensor controller 114 the identifications (IDs) of infrared rays insulated by an object, so that the sensor controller 114 specifies the coordinates of the touch position of the object. Here, IDs described in the following are examples of identification information.

Here, not only an infrared ray insulating method, the touch sensor 115 may employ other types of detection methods using a conductive touch panel which detects a change in capacitance to specify a touch position, a resistive touch panel which detects a change in voltage of two opposing resistance films to specify a touch position, an electromagnetic inductive touch panel which detects an electromagnetic induction resulting from a touch of an object on a display unit to specify a touch position, etc.

Furthermore, the electronic blackboard 2 includes an electronic pen controller 116. The electronic pen controller 116 performs communication with the electronic pen 4 in order to detect a touch of a pen tip or a pen end on the display 3. Here, not only the pen tip and the pen end of the electronic pen 4, but also the electronic pen controller 116 may be arranged so as to detect a touch of other parts of the electronic pen 4 such as a grip part.

The electronic blackboard 2 further includes a bus line 120 such as an address bus or a data bus for electrically connecting the CPU 101, the ROM 102, the RAM 103, the SSD 104, the network controller 105, the external memory controller 106, the capture device 111, the GPU 112, the sensor controller 114, and the electronic pen controller 116 as illustrated in FIG. 3.

Here, the program for the electronic blackboard 2 may be recorded on a computer-readable recording medium such as a CD-ROM for distribution.

<Functional Configuration of Electronic Blackboard>

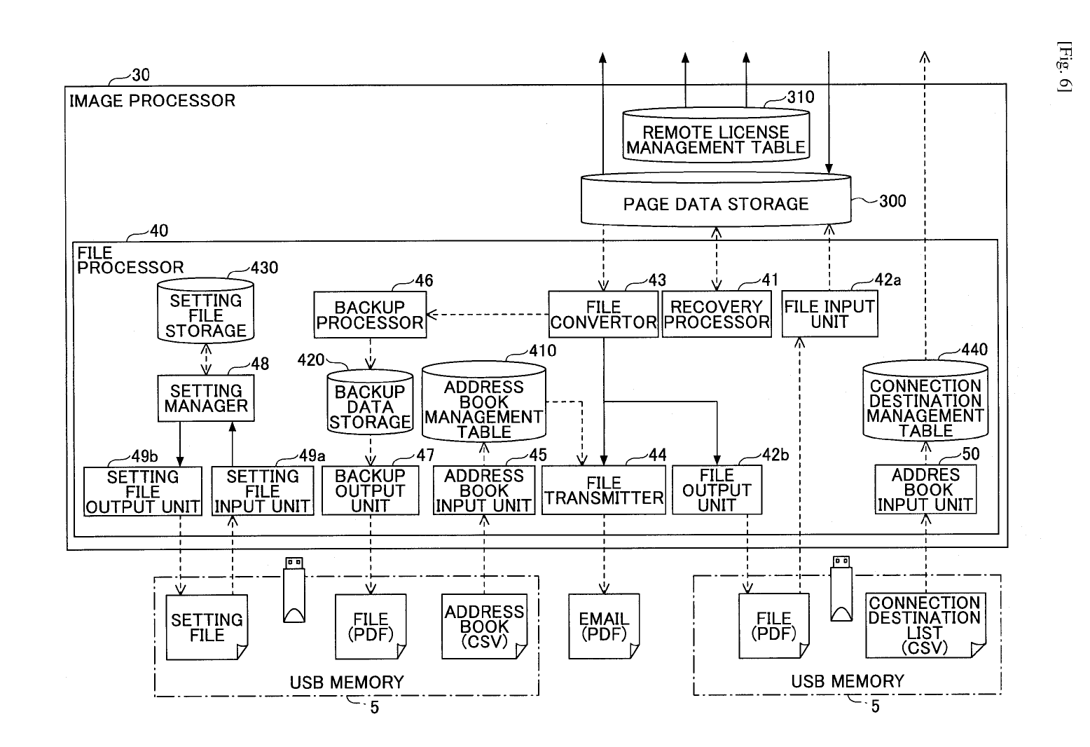

In the following, a functional configuration of the electronic blackboard 2 is described with reference to FIG. 5 through FIG. 8. Here, an overall functional configuration of the electronic blackboard 2 is firstly described with reference to FIG. 5. FIG. 5 is a block diagram illustrating the functional configuration of the electronic blackboard 2.

The functional configuration of the electronic blackboard 2 illustrated in FIG. 5 is implemented by the hardware configuration and programs as illustrated in FIG. 4. The electronic blackboard 2 may serve as a “host apparatus” that initiates remote-sharing processing as well as a “participating apparatus” that participates in initiated remote-sharing processing. Further, the electronic blackboard 2 is roughly divided into a client unit 20 and a server unit 90. The client unit 20 and the server unit 90 are implemented within the housing of a single electronic blackboard 2. When the electronic blackboard 2 serves as a host apparatus, the client unit 20 and the server unit 90 are implemented. When the electronic blackboard 2 serves as a participating apparatus, the client unit 20 is implemented whereas the server unit 90 is not implemented. For example, in FIG. 3, when the electronic blackboard 2a serves as a host apparatus and the electronic blackboard 2b serves as a participating apparatus, the client unit 20 of the electronic blackboard 2a performs communication with the client unit 20 of the counterpart electronic blackboard 2b via the server unit 90 implemented within the electronic blackboard 2a. On the other hand, the client unit 20 of the electronic blackboard 2b performs communication with the client unit 20 of the counterpart electronic blackboard 2a via the server unit 90 implemented within the counterpart electronic blackboard 2a, not the counterpart electronic blackboard 2b.

<Functional Configuration of Client Unit>

In the following, a functional configuration of the client unit 20 is described with reference to FIG. 5 through FIG. 7. The client unit 20 includes a video acquirer 21, a coordinate detector 22, an automatic adjuster 23, a touch detector 24, an event sorter 25, an operation processor 26, a gesture processor 27, a video superimposer 28, an image processor 30, and a communication controller 60.

The video acquirer 21 acquires an output video from a video outputting device that is connected to the cable 10. Upon receiving an image signal from the video outputting device, the video acquirer 21 analyzes the received image signal and derives image information such as the resolution of an image frame corresponding to an image formed by the image signal which is displayed on of the video outputting device, and the update frequency of the image frame, so as to output the image information to an image acquirer 31 of the image processor 30.

The coordinate detector 22 detects coordinates of an event generated by a user on the display 3 (e.g. touching the display 3 with the hand H of the user). Further, the coordinate detector 22 detects the dimensions of a touched region.

The automatic adjuster 23 is activated when the electronic blackboard 2 is activated (or reactivated). As the coordinate detector 22 detects coordinates using an optical sensor, the automatic adjuster 23 adjusts parameters used for processing an image in an optical sensor camera so that the coordinate detector 22 outputs appropriate values.

The touch detector 24 detects an event generated by the user (e.g. touching the display 3 with the pen tip or the pen end of the electronic pen 4).

The event sorter 25 sorts coordinates of an event detected by the coordinate detector 22 and a detection result of the touch detector 24 into event categories including a stroke drawing, a user interface (UI) operation, and a gesture operation.

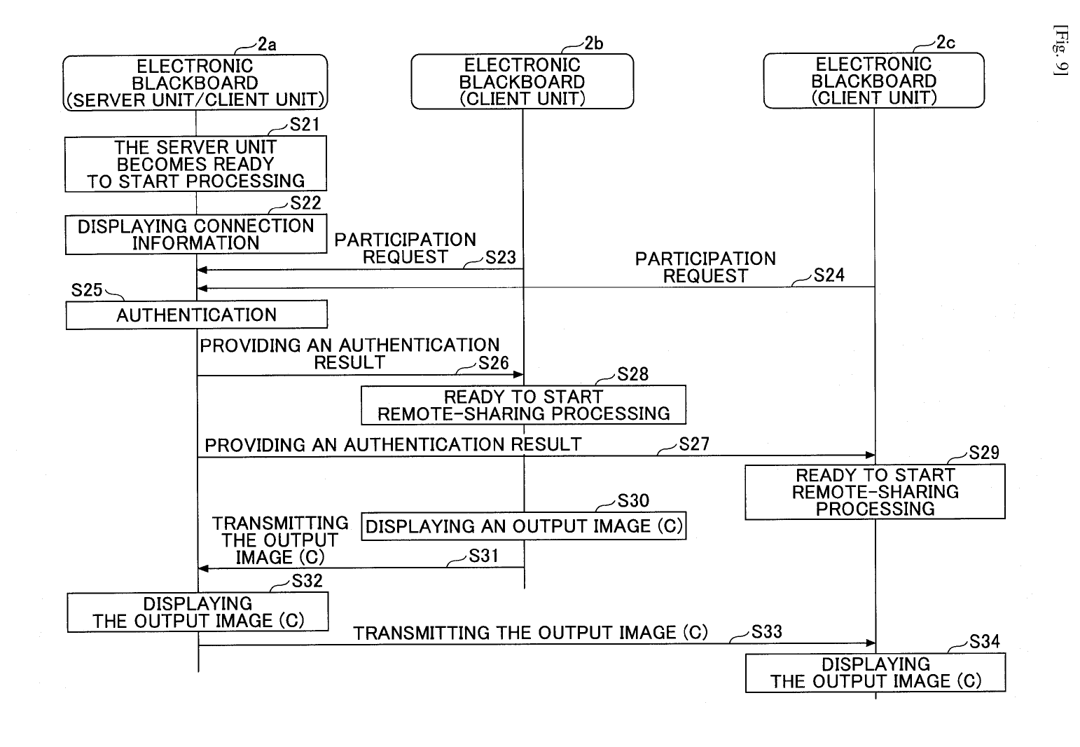

Here, the “stroke drawing” is an event that occurs when a stroke image (B) as illustrated in FIG. 8 (described in the following) is displayed on the display 3. In an event of the stroke drawing, a user touches the display 3 with the electronic pen 4, moves the electronic pen 4 while keeping the electronic pen 4 touched on the display 3, and then gets the electronic pen 4 off the display 3. For example, alphabet letters such as “S” and “T” may be drawn on the display 3 in an event of the stroke drawing. Here, the stroke drawing is not limited to an event of drawing an image but includes other events such as deleting a drawn image and editing a drawn image, etc.

The “UI operation” is an event that occurs when a UI image (A) as illustrated in FIG. 8 (described in the following) is displayed on the display 3. In an event of the UI operation, a user touches a predetermined position with the electronic pen 4 or the hand H. The thickness, color, etc., of a line drawn by the electronic pen 4 may be designated by an event of the UI operation.

The “gesture operation” is an event that occurs when the stroke image (B) as illustrated in FIG. 8 (described in the following) is displayed on the display 3. In an event of the gesture operation, a user touches or moves the hand H on the display 3. In an event of the gesture operation, the user moves the hand H while keeping the hand H touched on the display 3 so as to scale an image, change a display region, turn a page, etc.

When the event sorter 25 determines to sort an event into the UI operation, the operation processor 26 executes various operations according to UI elements associated with respective events. The UI elements include a button, a list, a checkbox, a textbox, etc. When the event sorter 25 determines to sort an event into the gesture operation, the gesture processor 27 executes various operations according to the respective gestures.

The video superimposer 28 displays images superimposed by a display superimposer 36 (described in the following) on a display unit 29 in a video format. The display unit 29 provides a display function which is implemented by the display 3. Furthermore, the video superimposer 28 provides a picture-in-picture function, in which a video transmitted from a video outputting device (such as the laptop computer 6) is displayed on a part of a video transmitted from another video outputting device (such as the teleconference terminal 7). Moreover, the video superimposer 28 switches the modes of a video displayed by the display unit 29 between a picture-in-picture mode and a full screen mode.

The image processor 30 performs processing such as superimposing multiple image layers as illustrated in FIG. 8. The image processor 30 includes the image acquirer 31, a stroke processor 32, a UI image generator 33, a background generator 34, a layout manager 35, the display superimposer 36, a page processor 37, a file processor 40, page data storage 300, and a remote license management table 310.

The image acquirer 31 acquires images of each frame of the video acquired by the video acquirer 21. The image acquirer 31 outputs the image data to the page processor 37. The images correspond to an output image (C) transmitted from a video outputting device (such as the laptop computer 6) as illustrated in FIG. 8.

The stroke processor 32 executes processing of drawing an image, deleting a drawn image, editing a drawn image, etc., in an event of the stroke drawing sorted by the event sorter 25. The image generated by the stroke drawing corresponds to the stroke image (B) as illustrated in FIG. 8. Furthermore, as described in the following, the outcomes of drawing, deleting, and editing an image in a stroke drawing event are stored in an operation data storage 840 as operation data.

The UI image generator 33 generates a UI image preset in the electronic blackboard 2. The UI image corresponds to a UI image (A) as illustrated in FIG. 8. The page processor 37 receives page data from the page data storage 300, and the background generator 34 receives from the page processor 37 media data out of the page data. The background generator 34 outputs the received media data to the display superimposer 36. Here, an image represented by the media data corresponds to a background image (D) as illustrated in FIG. 8. The pattern of the background image (D) may be a solid color or a grid display, etc.

The layout manager 35 manages layout information indicative of the layout of images output from the image acquirer 31, the stroke processor 32, and the UI image generator 33 (or the background generator 34). Hence, the layout manager 35 is capable of providing directions to the display superimposer 36 concerning the display positions of the output image (C) and the stroke image (B) disposed between the UI image (A) and the background image (D), as well as directions to display or hide the images.

The display superimposer 36 arranges the layouts of the images output from the image acquirer 31, the stroke processor 32, and the UI image generator 33 (or the background generator 34) based on the layout information output from the layout manager 35.

The page processor 37 assembles data of the stroke image (B) and data of the output image (C) in to a set of page data, and then stores the set of page data in the page data storage 300. The data of the stroke image (B) constitute a part of the page data as stroke arrangement data (stroke data), which are represented by stroke arrangement data IDs illustrated in Table 1. The data of the output image (C) constitute a part of the page data as media data, which are represented by media data IDs illustrated in Table 1. Further, when the page data storage 300 reads out the media data, the media data are processed as data of the background image (D).

Furthermore, the page processor 37 may transmit media data out of the stored page data to the display superimposer 36 via the background generator 34 so that the video superimposer 28 redisplays the background image (D) on the display 3. Moreover, the page processor 37 may return the stroke arrangement data (stroke data) out of the page data to the stroke processor 32, so as to enable re-editing of a stroke. Further, the page processor 37 may delete or replicate the page data.

In other words, when the page processor 37 stores page data in the page data storage 300, the output data (C) displayed on the display 3 at the moment is first stored in the page data storage 300, and then is read out of the page data storage 300 as media data representing a background image (D). The page processor 37 outputs stroke arrangement data representing the stroke image (B), which are included in media data read out of the page data storage 300, to the stroke processor 32. Further, the page processor 37 outputs media data representing the background image (D), which are included in media data read out of the page data storage 300, to the background generator 34.

The display superimposer 36 superimposes the output image (C) transmitted from the image acquirer 31, the stroke image (B) transmitted from the stroke processor 32, the UI image (A) transmitted from the UI image generator 33, and the background image (D) transmitted from the background generator 34 according to the layout specified by the layout manager 35. In this way, as illustrated in FIG. 8, the images are layered in an order of the UI image (A), the stroke image (B), the output image (C), and the background image (D) from the view point of a user.

Furthermore, the display superimposer 36 may switch between the output image (C) and the background image (D) so as to superimpose either one of the output image (C) or the background image (D) on the UI image (A) and the stroke image (B) in an exclusive manner. For example, in a case where the cable 10 which connects the electronic blackboard 2 and the video outputting device (such as the laptop computer 6) is unplugged while initially the UI image (A), the stroke image (B), and the output image (C) are displayed, the layout manager 35 may direct to exclude the output image (C) from the superimposed images and display the background image (D) instead. In such a case, the display superimposer 36 executes processing for scaling images, moving display regions, etc.

The page data storage 300 stores page data as illustrated in Table 1.

TABLE 1

| | | | STROKE | |
|---|---|---|---|---|
| PAGE | | | ARRANGE- | MEDIA |
| DATA | | | MENT | DATA |
| ID | START TIME | END TIME | DATA ID | ID |
| p001 | 20130610102434 | 20130610102802 | st001 | m001 |
| p002 | 20130610102815 | 20130610103225 | st002 | m002 |
| p003 | 20130610103545 | 20130610104233 | st003 | m003 |
| . . . | . . . | . . . | . . . | . . . |

Table 1 conceptually indicates page data. Page data, such as stroke arrangement data (stroke data) and media data, constitute a page displayed on the display 3. Here, the page data are explained with reference to Table 1 through Table 4, in order to cover a wide variety of parameters included in the page data.

As illustrated in Table 1, page data are stored, associating a page data ID for identifying a page, a start time indicating the time when a page is displayed, an end time indicating the time when rewriting of the page through stroke drawing, gesture operations, etc., is ended, a stroke arrangement data ID for identifying stroke arrangement data generated by a stroke of the electronic pen 4 or the hand H, and a media data ID for identifying media data. The stroke arrangement data corresponds to data for displaying the stroke image (B) illustrated in FIG. 8 on the display 3 as described in the following description. Media data corresponds to data for displaying the background image (D) illustrated in FIG. 8 on the display 3 (D) as described in the following description.

Hence, in a case where a user draws an alphabet letter “S” using the electronic pen 4, the alphabet letter “S” is represented with one stroke ID as the alphabet letter “S” is written with one stroke. On the other hand, in a case where a user draws an alphabet letter “T” using the electronic pen 4, the alphabet letter “T” is represented with two stroke IDs as the alphabet letter “T” is written with two strokes.

Further, the stroke arrangement data include detailed information as illustrated in Table 2. Table 2 conceptually indicates the stroke arrangement data. As illustrated in Table 2, stroke arrangement data are represented with multiple stroke data. One set of stroke data includes a stroke ID for identifying stroke data, a start time indicating the time when a stroke is performed, an end time indicating the time when a stroke is ended, a stroke color, a stroke width, and a coordinate arrangement data ID for identifying the pass points of the arrangement of the strokes.

Furthermore, the coordinate arrangement data include detailed information as illustrated in Table 3. Table 3 conceptually indicates the coordinate arrangement data. As illustrated in Table 3, the coordinate arrangement data include the coordinates of the display 3 (X-coordinate and Y-coordinate), a time difference (ms) between the start time of a stroke and the time the stroke passes the coordinates, and a pen pressure of the electronic pen 4 at the coordinates. That is to say, a collection of coordinates as illustrated in Table 3 represents one set of the stroke arrangement data as illustrated in Table 2. For example, in a case where a user draws an alphabet letter “S” using the electronic pen 4, the alphabet letter “S” is written with one stroke, but the stroke passes through multiple coordinates until the end of the stroke. Hence, the coordinate arrangement data is represented with information of the multiple coordinates.

The media data of the page data illustrated in Table 1 include detailed information as illustrated in Table 4.

TABLE 4

| MEDIA | DATA | RECORDING | | | | | |
|---|---|---|---|---|---|---|---|
| DATA ID | TYPE | TIME | X-COORDINATE | Y-COORDINATE | WIDTH | HEIGHT | DATA |
| m001 | IMAGE | 20130610103432 | 0 | 0 | 1920 | 1080 | abc.jpg |
| m002 | IMAGE | 20130610105402 | 277 | 156 | 1366 | 768 | bcd.jpg |
| m003 | IMAGE | 20130610105017 | 277 | 156 | 1366 | 768 | cde.jpg |
| . | . | . | . | . | . | . | . |
| . | . | . | . | . | . | . | . |
| . | . | . | . | . | . | . | . |

Table 4 conceptually indicates the media data. As illustrated in Table 4, the media data are stored, associating the media data ID of the page data illustrated in Table 1, a data type of the media data, a recording time when the page processor 37 stores the page data in the page data storage 300, a position (X coordinate and Y coordinate) and a size (width and height) of an image displayed on the display 3 based on the page data, and data indicating the content of the media data. Here, the position of the image displayed on the display 3 based on the page data represents the upper left corner of a displayed image, assuming that the coordinates of the upper left corner of the display 3 are (X-coordinate, Y-coordinate)=(0, 0).

Referring back to FIG. 5, the remote license management table 310 manages license data used for executing a remote-sharing process. As illustrated in FIG. 5, the remote license management table 310 stores a product ID of the electronic blackboard 2, a license ID used for authentication, and a license expiration date, in association with each other.

TABLE 5

| | | EXPIRATION |
|---|---|---|
| PRODUCT ID | LICENSE ID | DATA |
| 1001 | 12345678abcdefgh | 2012/12/31 |
| 1001 | 4321dcba8765hgfe | — |
| . . . | . . . | . . . |

<Functional Configuration of File Processor>

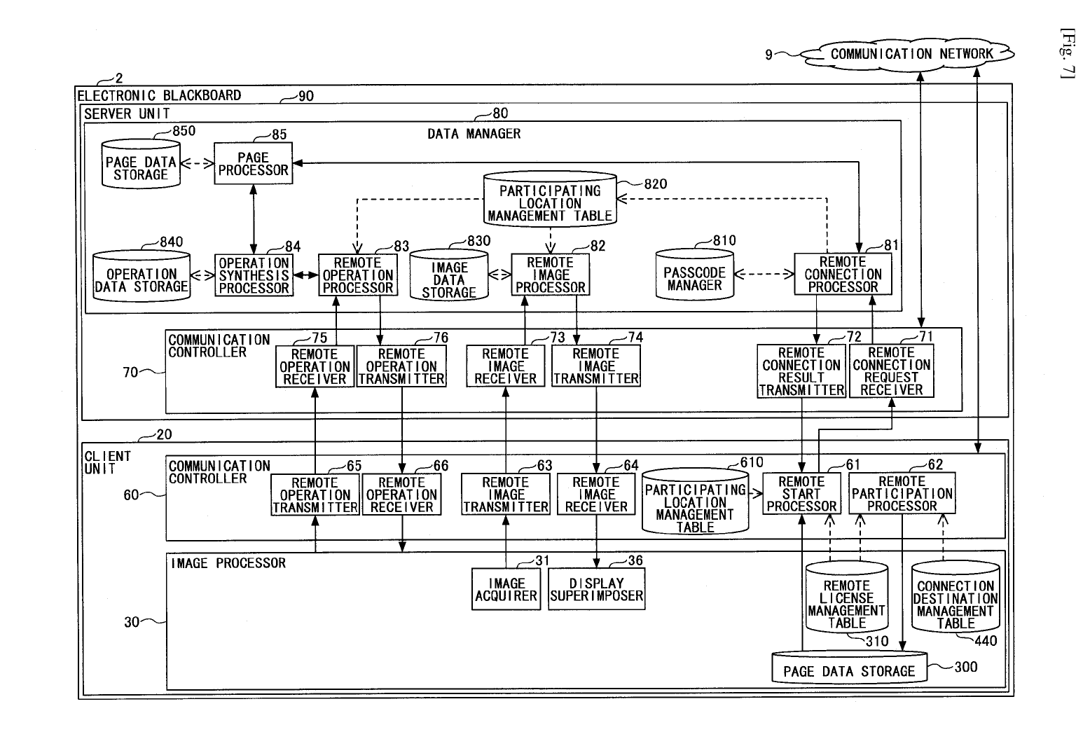

In the following, a functional configuration of the file processor 40 illustrated in FIG. 5 is described with reference to FIG. 6. Here, FIG. 6 is a functional block diagram illustrating the file processor 40.

The file processor 40 includes a recovery processor 41, a file input unit 42a, a file output unit 42b, a file convertor 43, a file transmitter 44, an address book input unit 45, a backup processor 46, a backup output unit 47, a setting manager 48, a setting file input unit 49a, and a setting file output unit 49b. The file processor 40 further includes an address book management table 410, a backup data storage 420, a setting file storage 430, and a connection destination management table 440.

The recovery processor 41 detects an abnormal shutdown of the electronic blackboard 2, and then recovers page data that are not properly stored. For example, in a case of a normal shutdown, page data are stored as a PDF file in the USB memory 5 via the file processor 40. However, in a case of an abnormal shutdown due to power failure, etc., the page data are stored in the page data storage 300. Thus, when the power is turned back on, the recovery processor 41 retrieves the page data from the page data storage 300 for recovery.

The file input unit 42a reads out a PDF file from the USB memory 5 and stores each page of the PDF file as page data in the page data storage 300. The file convertor 43 converts the page data stored in the page data storage 300 into a PDF file.

The file output unit 42b stores the PDF file output from the file convertor 43 in the USB memory 5.

The file transmitter 44 sends the PDF file generated by the file convertor 43, attached to an email. The display superimposer 36 displays contents of the address book management table 410 on the display 3 and the file transmitter 44 accepts a user selection of the destination through an operation on an input unit such as a touch panel, etc., so that the destination of the file is determined. As illustrated in Table 6, the address book management table 410 stores a name and an email address of a destination, associating with each other.

TABLE 6

| NAME | EMAIL ADDRESS |
|---|---|
| TARO | taro@alpha.co.jp |
| HANAKO | hanako@beta.co.jp |
| — | jiro@gamma.co.jp |
| . . . | . . . |

Further, the file transmitter 44 may accept an input of an email address through a user operation on an input unit such as a touch panel, etc.

The address book input unit 45 reads out a list file of email addresses from the USB memory 5 and manages in the address book management table 410.

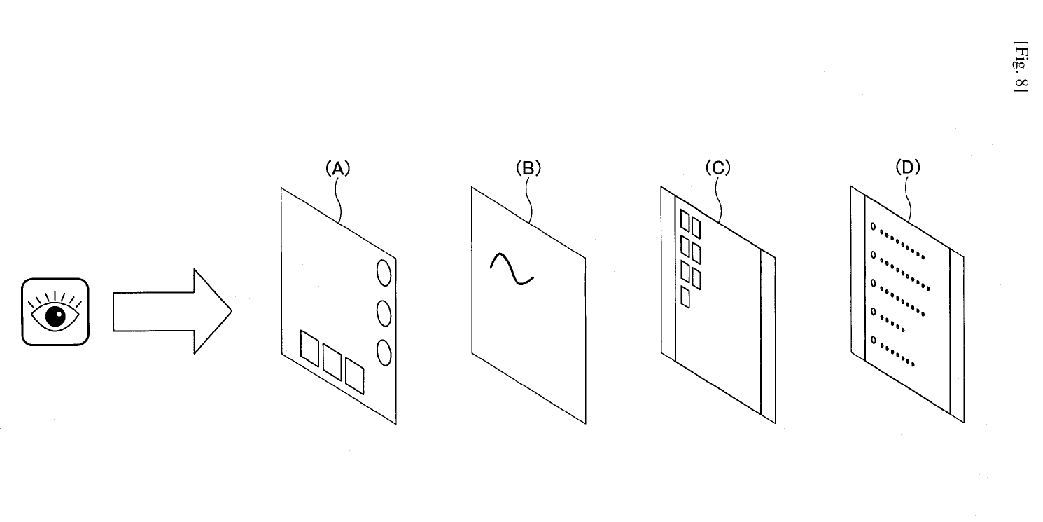

The backup processor 46 stores a file output from the file output unit 42b or a file transmitted by the file transmitter 44 in the backup data storage 420 as a backup. Here, the backup process is not performed unless the user sets up the backup processor 46 for a backup setting. The backup data are stored in a PDF format as illustrated in FIG. 7.

TABLE 7

iwb_20130610104423.pdf
iwb_20130625152245.pdf
iwb_20130628113418.pdf
. . .

The backup output unit 47 stores the backup file in the USB memory 5. Upon storing the backup file, the user is prompted to enter a passcode for security purposes through an operation on an input unit such as a touch panel.

The setting manager 48 stores setting information of the electronic blackboard 2 in the setting file storage 430 and reads out the setting information from the setting file storage 430 for management. The setting information of the electronic blackboard 2 may be network settings, time/date settings, region/language settings, mail server settings, address book settings, connection destination list settings, and backup related settings. Here, the network settings may include an Internet protocol (IP) address setting of the electronic blackboard 2, a netmask setting, a default gateway setting, and a Domain Name System (DNS) setting.

The setting file output unit 49b stores the setting information of the electronic blackboard 2 in the USB memory 5 as a setting file. Here, the content of the setting file may not be viewed by the user for a security reason.

The setting file input unit 49a reads out a setting file stored in the USB memory 5 and applies the setting information to the relevant settings of the electronic blackboard 2.

The address book input unit 50 reads out a list file of IP addresses of connection destinations for performing a remote-sharing process from the USB memory 5, so as to manage the list file in the connection destination management table 440. Table 8 illustrates an example of the connection destination management table 440.

TABLE 8

| NAME | IP ADDRESS |
|---|---|
| CONFERENCE ROOM 1 | 192.0.0.1 |
| CONFERENCE ROOM 2 | 192.0.0.2 |
| — | 192.0.0.3 |
| . . . | . . . |

The connection destination management table 440 manages IP addresses of the electronic blackboards 2 that serve as a host apparatus, so that, in a case where an electronic blackboard 2 serves as a participating apparatus to participate in remote-sharing processing, the user of the participating apparatus need not enter the IP address of the host apparatus. The destination management table 440 manages a name of a location and an IP address of the electronic blackboard 2 serving as a host apparatus ready for participations of participating apparatuses, in association with each other.

Here, the destination management table 440 is not necessary. However, without the destination management table 440, the user of the participating apparatus need enter the IP address of the host apparatus through an operation on an input unit such as a touch panel to start performing a remote-sharing processing with the host apparatus. Here, the user of the participating apparatus may acquire the IP address of the host apparatus from the user of the host apparatus via a telephone call or an e-mail.

<Functional Configuration of Communication Controller 60>

In the following, a functional configuration of the communication controller 60 is described with reference to FIG. 7. FIG. 7 is a functional block diagram illustrating examples of a server unit 90 and the client unit 20. The communication controller 60 controls communications with another electronic blackboard 2 via the communication network 9 and communications with the communication controller 70 of the server unit 90 (described in the following). The communication controller 60 includes a remote start processor 61, a remote participation processor 62, a remote image transmitter 63, a remote image receiver 64, a remote operation transmitter 65, a remote operation receiver 66, and a participating location management table 610.

The remote start processor 61 sends a request to start a new remote-sharing process to the server unit 90 within the same electronic blackboard 2, and then receives a response from the server unit 90. Here, the remote start processor 61 refers to the remote license management table 310 to determine whether license information (such as a product ID, a license ID, and an expiration date). If the license information is managed in the remote license management table 310, the remote start processor 61 may send a request to start remote-sharing processing. On the other hand, in a case where the license information is not managed in the remote license management table 310, the remote start processor 61 may not send a request to start the remote-sharing processing.

The participating location management table 610 of a host apparatus manages electronic blackboards 2 serving as participating apparatuses in currently performed remote-sharing processing. Table 9 is an example of the participating location management table 610.

TABLE 9

| NAME | IP ADDRESS |
|---|---|
| CONFERENCE ROOM 1 | 192.0.0.1 |
| CONFERENCE ROOM 2 | 192.0.0.2 |
| — | 192.0.0.8 |
| . . . | . . . |

The participating location management table 610 manages a location name and an IP address of a participating electronic blackboard 2, in a corresponding manner.

The remote participation processor 62 sends a participation request for participating in remote-sharing processing to a remote connection request receiver 71 of the server unit 90 of the electronic blackboard 2 serving as a host apparatus of currently performed remote-sharing processing via the communication network 9. Here, the remote participation processor 62 refers to the remote license management table 310 as well. Further, in a case where the remote participation processor 62 sends a request to participate in the currently performed remote-sharing processing, the remote participation processor 62 refers to the connection destination management table 440 in order to acquire the IP address of the electronic blackboard 2 to be connected to. Here, the remote participation processor 62 may not refer to the connection destination management table 440. In such a case, a user enters the IP address of the electronic blackboard to be connected to through an operation on an input unit such as a touch panel.

The remote image transmitter 63 receives the output image (C) from the video acquirer 21 via the image acquirer 31, and then transmits the received output image (C) to the server unit 90.

The remote image receiver 64 receives image data from a video outputting device connected to another electronic blackboard 2 via the server unit 90, and then outputs the received image data to the display superimposer 36, so as to enable remote-sharing processing.

The remote operation transmitter 65 transmits operation data used for remote-sharing processing to the server unit 90. The operation data may include, for example, data relating to operations such as adding a stroke, deleting a stroke, editing a stroke (e.g. zoom in, zoom out, move), storing page data, creating page data, duplicating page data, deleting page data, and switching a displayed page. The remote control receiving unit 66 receives from the server unit 90 operation data entered through another electronic blackboard 2, and then outputs the received operation data to the image processor 30, so as to perform remote-sharing processing.

<Functional Configuration of Server Unit>

In the following, a functional configuration of the server unit 90 is described with reference to FIG. 7. The server unit 90 is included in an electronic blackboard 2 and serves for any electronic blackboards 2. The server unit 90 includes a communication controller 70 and a data manager 80.

<Functional Configuration of Communication Controller>

In the following, a functional configuration of the communication controller 70 is described with reference to FIG. 7.

The communication controller 70 controls communications with the communication controller 60 of the client unit 20 within the same electronic blackboard 2 as well as communications with the communication controller 60 of the client unit of another electronic blackboard 2 via the communication network 9. The data manager 80 manages data such as operation data and image data.

Furthermore, the communication controller 70 includes the remote connection request receiver 71, a remote connection result transmitter 72, a remote image receiver 73, a remote image transmitter 74, a remote operation receiver 75, and a remote operation transmitter 76.

The remote connection request receiver 71 receives from the remote start processor 61 a request for starting remote-sharing processing, and receives from the remote participation processor 62 a request for participating in remote-sharing processing. The remote connection result transmitter 72 transmits to the remote start processor 61 a response to the request for starting the remote-sharing processing, and transmits to the remote participation processor 62 a response to the request for participating in the remote-sharing processing.

The remote image receiver 73 receives image data (data of output image (C)) from the remote image transmitter 63, and then transmits the received image data to a remote image processor 82 (described in the following). The remote image transmitter 74 receives image data from the remote image processor 82, and then transmits the received image data to the remote image receiver 64.

The remote operation receiver 75 receives operation data (data of stroke image (B)) from the remote operation transmitter 65, and then transmits the received operation data to a remote operation processor 83 (described in the following). The remote operation transmitter 76 receives operation data from the remote operation processor 83, and then transmits the received operation data to the remote operation receiver 66.

<Functional Configuration of Data Manager>

In the following, a functional configuration of the data manager 80 is described with reference to FIG. 7. The data manager 80 includes a remote connection processor 81, the remote image processor 82, the remote operation processor 83, an operation synthesis processor 84, and a page processor 85. Further, the server unit 90 includes a passcode manager 810, a participating location management table 820, an image data storage 830, the operation data storage 840, and a page data storage 850.

The remote connection processor 81 starts remote-sharing processing and terminates the remote-sharing processing. The remote connection processor 81 also detects license information received by the remote connection request receiver 71 from the remote start processor 61 together with a request for starting remote-sharing processing or license information received by the remote connection request receiver 71 from the remote participation processor 62 together with a request for participating in remote-sharing processing, and detects whether the license information is valid, considering expiration dates. Further, the remote connection processor 81 detects whether the number of participation requests received from other electronic blackboards 2 serving as client apparatuses exceeds a predetermined number for allowing participations.

Further, the remote connection processor 81 determines whether a passcode received along with a request for participating in remote-sharing processing from another electronic blackboard 2 matches a passcode managed in the passcode manager 810. In a case where the passcode matches, the request for participating in the remote-sharing processing is accepted. Here, the passcode is produced by the remote connection processor 81 upon starting new remote-sharing processing, and the passcode may be communicated via a telephone call and an e-mail from a user of the electronic blackboard 2 serving as a host apparatus to a user of another electronic blackboard 2 serving as a participating apparatus that requests for participating in the remote-sharing processing. Then, the user of the other electronic blackboard 2 serving as a participating apparatus that requests for participating in the remote-sharing processing may enter the passcode through the participating apparatus through a touch panel, etc., before sending a participation request, so that the transmitted participation request is accepted. Here, the participation request may be accepted only through a confirmation of license information, without a confirmation of the passcode, to improve convenience for a user.

Furthermore, in a case where the electronic blackboard 2 serves as a host apparatus, the remote connection processor 81 stores participating location information included in a participation request sent via the communication network 9 from the remote participation processor 62 of a participating apparatus, in the participating location management table 820 of the server unit 90. The remote connection processor 81 then reads out the remote location information stored in the participating location management table 820 and transmits the remote location information to the remote connection result transmitter 72. The remote connection result transmitter 72 transmits the remote location information to the remote start processor 61 of the client unit 20 of the same electronic blackboard 2 serving as the host apparatus. The remote start processor 61 stores the remote location information in the participating location management table 610. In this way, the host apparatus manages the remote location information in both the client unit 20 and the server unit 90.

The remote image processor 82 receives image data (such as output image (C)) from a video outputting device (such as laptop computer 6) connected to a client unit 20 of each electronic blackboard 2 involved in remote-sharing processing (including the client unit 20 within the electronic blackboard 2 serving as a host apparatus), and then stores the received image data in the image data storage 830. In the meantime, the remote image processor 82 determines the order of displaying the image data during the remote-sharing processing, according to the chronological order of the image data received by the server unit 90 of the electronic blackboard 2 serving as the host apparatus. Further, the remote image processor 82 refers to the participating location management table 820, so as to transmit the image data via the communication controller 70 (remote image transmitter 74) to the client unit 20 of each electronic blackboard 2 involved in the remote-sharing processing (including the client unit 20 within the electronic blackboard 2 serving as the host apparatus), in the determined order as described above.

The remote operation processor 83 receives operation data (such as stroke image (B)) produced on a client unit 20 of each electronic blackboard 2 involved in remote-sharing processing (including the client unit 20 within the electronic blackboard 2 serving as the host apparatus), and then determines the order of displaying the image data during the remote-sharing processing, according to the chronological order of the image data received by the server unit 90 of the electronic blackboard 2 serving as the host apparatus. Here, the operation data are the same as the operation data explained in the above description. Further, the remote operation processor 83 refers to the participating location management table 820, so as to transmit the operation data to the client unit 20 of each electronic blackboard 2 involved in the remote-sharing processing (including the client unit 20 within the electronic blackboard 2 serving as the host apparatus).

The operation synthesis processor 84 synthesizes the operation data of each electronic blackboard 2 output from the remote operation processor 83, stores the synthesized operation data in the operation data storage 840, and then returns the synthesized operation data to the remote operation processor 83. The operation data are transmitted to the client unit 20 of the electronic blackboard 2 serving as the host apparatus and the client unit 20 of each of the electronic blackboards 2 serving as participating apparatuses, so that the same image relating to the operation data is displayed on each of the electronic blackboards 2. Table 10 is an example of the operation data.

TABLE 10

| | | | | | OBJECT OF | |
|---|---|---|---|---|---|---|
| | | SOURCE IP | DESTINATION IP | | OPERATION | |
| | NAME | ADDRESS: | ADDRESS: | TYPE | (PAGE DATA | |
| | OF | PORT | PORT | OF | ID/STROKE | |
| SEQ | OPERATION | NO. | NO. | OPERATION | DATA ID) | DATA |
| 1 | ADD | 192.0.0.1: 50001 | 192.0.0.1: 50000 | STROKE | p005 | (STROKE DATA) |
| 2 | ADD | 192.0.0.1: 50000 | 192.0.0.2: 50001 | STROKE | p005 | (STROKE DATA) |
| 3 | UPDATE | 192.0.0.2: 50001 | 192.0.0.1: 50000 | STROKE | s006 | (50, 40) |
| 4 | UPDATE | 192.0.0.1: 50000 | 192.0.0.1: 50001 | STROKE | s006 | (50, 40) |
| 5 | DELETE | 192.0.0.2: 50001 | 192.0.0.1: 50000 | STROKE | s007 | — |
| 6 | DELETE | 192.0.0.1: 50000 | 192.0.0.1: 50001 | STROKE | s007 | — |
| 7 | ADD | 192.0.0.1: 50001 | 192.0.0.1: 50000 | PAGE | — | — |
| 8 | ADD | 192.0.0.1: 50000 | 192.0.0.2: 50001 | PAGE | — | — |
| 9 | ADD | 192.0.0.2: 50001 | 192.0.0.1: 50000 | IMAGE | p006 | aaa.jpg |
| 10 | ADD | 192.0.0.1: 50000 | 192.0.0.1: 50001 | IMAGE | p006 | aaa.jpg |
| . | . | . | . | . | . | . |
| . | . | . | . | . | . | . |
| . | . | . | . | . | . | . |

As illustrated in Table 10, the operation data include a sequence number (SEQ), a name of operation, an IP address of an electronic blackboard 2 that transmits operation data and a port number of a client unit (or a server unit), an IP address of an electronic blackboard 2 that receives the operation data and a port number of a client unit (or a server unit), a type of operation, an object of operation, and a content of the operation data, in a manner so that each items are correspond with each other. For example, SEQ 1 indicates that a stroke is drawn on the client unit 20 (Port No.: 50001) of the electronic blackboard 2 serving as a host apparatus (IP address: 192.0.0.1), and then operation data relating to the stroke is sent to the server unit 90 (Port No.: 50000) of the same electronic blackboard 2 serving as the host apparatus (IP address: 192.0.0.1). Here, according to the operation data, the type operation is “STROKE”, the object of operation is the page data ID “p005”, and the content of the operation data is stroking. Further, SEQ 2 indicates that operation data is sent from the server unit 90 (Port No.: 50000) of the electronic blackboard 2 serving as the host apparatus to the client unit 20 (Port No.: 50001) of another electronic blackboard 2 serving as a participating apparatus (IP address: 192.0.0.1).

Here, the operation synthesis processor 84 synthesizes the operation in order of inputting to the operation synthesis processor 84. Accordingly, as long as the communication network 9 is not congested, a stroke image (B) is displayed on the display 3 of each of the electronic blackboards 2 involved in the remote-sharing processing each time a stroke is drawn by a user of the respective electronic blackboards 2.

The page processor 85 has a function similar to the function of the page processor 37 provided in the image processor 30 of the client unit 20. That is, in the server unit 90 as well, the page processor 85 stores page data as illustrated in Table 1 through Table 3 in the page data storage 850. Here, the page data storage 850 has substantially the same configuration as the page data storage 300 provided in the image processor 30, and therefore, descriptions of the page data storage 850 are omitted.

<Processing/Operation of Embodiments>

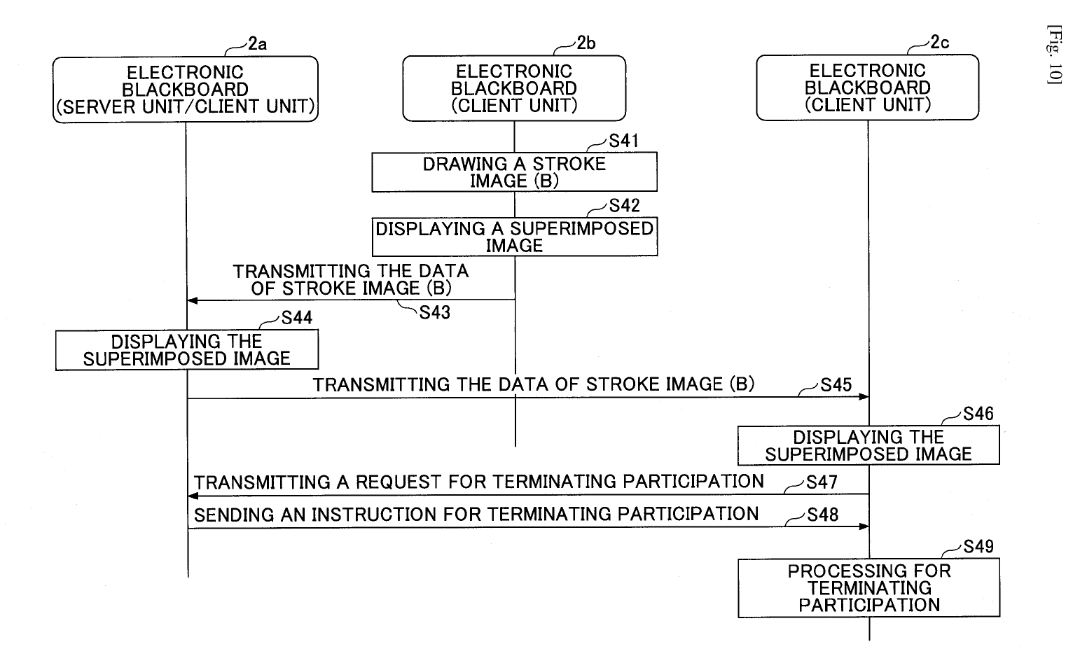

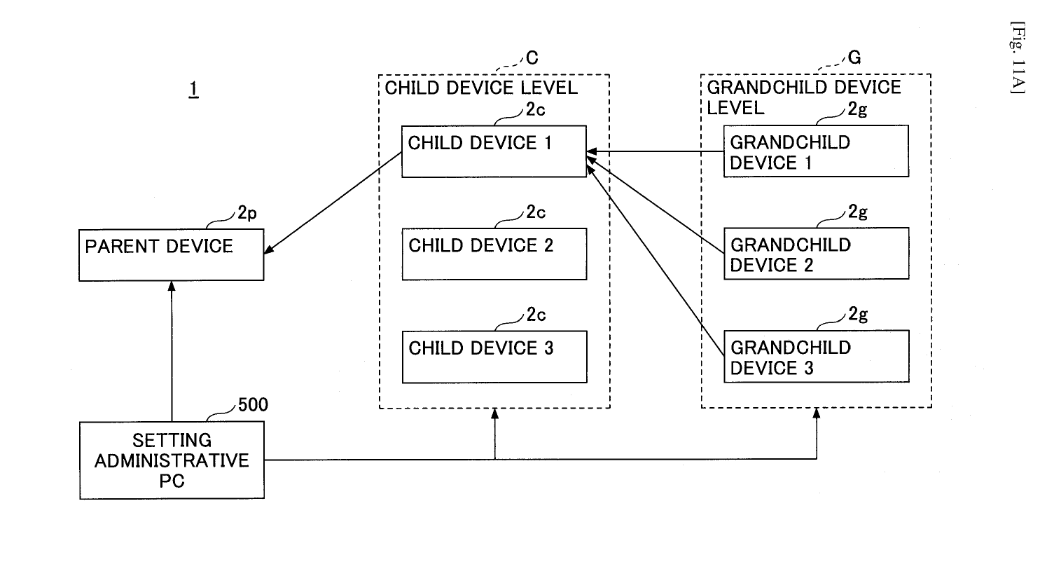

In the following, processing and operation in the embodiments of the present invention are described with reference to FIGS. 9 and 10. FIGS. 9 and 10 are sequence diagrams illustrating examples of processing performed in the electronic blackboards 2a through 2c. Here, in FIGS. 9 and 10, the electronic blackboard 2a serves as a host apparatus (implementing a server unit and a client unit) that hosts remote-sharing processing, and the electronic blackboards 2b and 2c serve as participating apparatuses (implementing a client unit) that participate in the remote-sharing processing. Here, displays 3a, 3b, and 3c as well as laptop computers 6a, 6b, and 6c are connected to the electronic blackboards 2a, 2b and 2c, respectively. Further, electronic pens 4a, 4b, and 4c are provided for the electronic blackboards 2a, 2b, and 2c, respectively.

(Participation Processing)

First, processing for the electronic blackboards 2b and 2c to participate in remote-sharing processing is described below, with reference to FIG. 9.

When a user turns on the power of the electronic blackboard 2a, the client unit 20 of the electronic blackboard 2a is activated. Then, responding to a user operation through an input unit such as a touch panel to activate the server unit 90, the remote start processor 61 provided in the client unit 20 of the electronic blackboard 2a outputs an instruction to the remote connection request receiver 71 provided in the server unit 90 of the same electronic blackboard 2a for starting processing of the server unit 90. In this way, not only the client unit 20 but also the server unit 90 of the electronic blackboard 2a become ready to start processing (step S21).

Subsequently, the UI image generator 33 provided in the client unit 20 of the electronic blackboard 2a generates connection information used for connecting to the electronic blackboard 2a, and then the video superimposer 28 acquires the connection information from the UI image generator 33 via the display superimposer 36, so as to display the connection information on the display 3a (step S22).

The connection information includes the IP address of the host apparatus and a passcode generated for a remote-sharing processing. Here, the passcode stored in the passcode manager 810 is retrieved by the remote connection processor 81 and transmitted from the remote connection processor 81 to the remote connection result transmitter 72 and then from the remote connection result transmitter 72 to the remote start processor 61. Furthermore, the passcode is transmitted from the communication controller 60, in which the remote start processor 61 is provided, to the image processor 30 as illustrated in FIG. 5, and then is ultimately input to the UI image generator 33. In this way, the passcode is included in the connection information. Then, the user of the electronic blackboard 2a may communicate the connection information to the users of the electronic blackboards 2b and 2c via a telephone or an e-mail. Here, when the connection destination management table 440 is provided on a participating apparatus, the participating apparatus may send a participating request even though an IP address of a host apparatus is not included in connection information.

Next, responding to an input of the connection information through a user operation using an input unit such as a touch panel, the remote participation processor 62 provided in the client unit 20 of each of the electronic blackboards 2b and 2c sends a participation request along with the passcode to the communication controller 70 provided in the server unit 90 of the electronic blackboard 2a via the communication network 9, referring to the IP address included in the connection information (steps S23 and S24). In this way, the remote connection request receiver 71 provided in the communication controller 70 receives the participation requests (including the passcodes) from the electronic blackboards 2b and 2c, and then outputs the passcodes to the remote connection processor 81.

Then, the remote connection processor 81 authenticates the passcodes received from the electronic blackboards 2b and 2c, referring to the passcode stored in the passcode manager 810 (step S25).

Then, the remote connection result transmitter 72 provides an authentication result to the client units 20 of the electronic blackboards 2b and 2c (steps S26 and S27).

In a case where the electronic blackboards 2b and 2c are successfully authenticated in the authentication process of step S25, communication for the remote-sharing processing is established between the electronic blackboard 2a serving as the host apparatus and the electronic blackboards 2b and 2c serving as the participating apparatuses, which enables the remote participation processors 62 provided in the client units 20 of the respective electronic blackboards 2b and 2c to start remote-sharing processing with the other electronic blackboards (steps S28 and S29).

(Displaying Output Image)

In the following, processing for displaying an output image (C) in the remote-sharing processing is described with reference to FIG. 9.

First, the electronic blackboard 2b displays an output image (C) on the display 3b (step S30 of FIG. 9). Specifically, the image acquirer 31 provided in the electronic blackboard 2b receives data of the output image (C) displayed on the laptop computer 6b from the laptop computer 6b through the video acquirer 21, and then transmits the received image data to the display 3b through the display superimposer 36 and the video superimposer 28. In this way, the output image (C) is displayed on the display 3b.

Then, the image processor 30 of the electronic blackboard 2b, in which the image acquirer 31 is provided, transmits the data of the output image (C) to the remote image transmitter 63, so that the communication controller 60, in which the remote image transmitter 63 is provided, transmits the data of the output image (C) via the communication network 9 to the communication controller 70 of the electronic blackboard 2a serving as the host apparatus (step S31). In this way, the remote image receiver 73 of the electronic blackboard 2a receives the data of the output image (C), and then outputs the received data to the remote image processor 82, so that the remote image processor 82 stores the data of the output image (C) in the image data storage 830.

Then, the electronic blackboard 2a serving as the host apparatus displays the output image (C) on the display 3a (step S32). Specifically, the remote image processor 82 of the electronic blackboard 2a outputs the data of the output image (C) received from the remote image receiver 73 to the remote image transmitter 74. The remote image transmitter 74 outputs the data of the output image (C) to the remote image receiver 64 provided in the client unit 20 of the same electronic blackboard 2a serving as the host apparatus. The remote image receiver 64 outputs the data of the output image (C) to the display superimposer 36. The display superimposer 36 outputs the data of the output image (C) to the video superimposer 28. The video superimposer 28 outputs the data of the output image (C) to the display 3a. In this way, the output image (C) is displayed on the display 3a.

Then, the communication controller 70, in which the remote image transmitter 74 is provided, of the server unit 90 of the electronic blackboard 2a serving as the host apparatus transmits the data of the output image (C) via the communication network 9 to the communication controller 60 provided in another electronic blackboard 2c, not to the electronic blackboard 2b which is the sender of the data of the output image (C) (step S33). In this way, the remote image receiver 64 provided in the electronic blackboard 2c serving as one of the participating apparatuses receives the data of the output image (C).

Then, the electronic blackboard 2c displays the output image (C) on the display 3c (step S34). Specifically, the remote image receiver 64 provided in the electronic blackboard 2c outputs the data of the output image (C) received in step S33 as described above to the display superimposer 36 provided in the electronic blackboard 2c. The display superimposer 36 outputs the data of the output image (C) to the video superimposer 28. The video superimposer 28 outputs the data of the output image (C) to the display 3c. In this way, the output image (C) is displayed on the display 3c.

Here, in a case where data of the UI image (A) and the stroke image (B), in addition to the output image (C), are provided to the display superimposer 36, the display superimposer 36 generates an superimposed image (A, B, C), and then the video superimposer 28 outputs the superimposed image (A, B, C) to the display 3c. Furthermore, in a case where a video (E) for teleconferencing is provided to the video superimposer 28 from the teleconference terminal 7, the video superimposer 28 superimposes the video (E) for teleconferencing on the superimposed image (A, B, C) in a picture-in-picture format, and then outputs the video (E) to the display 3c.

(Displaying Superimposed Image)

In the following, processing for displaying a superimposed image during the remote-sharing processing is described with reference to FIG. 10.

First, the user draws a stroke image (B) on the electronic blackboard 2b using the electronic pen 4b (step S41).

Then, as illustrated in FIG. 8, the display superimposer 36 provided in the electronic blackboard 2b superimposes the stroke image (B) on the UI image (A) and the output image (C), so that the video superimposer 28 displays the superimposed image (A, B, C) on the display 3b of the electronic blackboard 2b (step S42). Specifically, the stroke processor 32 provided in the electronic blackboard 2b receives the data of the stroke image (B) as operation data from the coordinate detector 21 and the touch detector 24 via the event sorter 25, and then transmits the received data to the display superimposer 36. In this way, the display superimposer 36 superimposes the stroke image (B) on the UI image (A) and the output image (C), and the video superimposer 28 displays the superimposed image (A, B, C) on the display 3b of the electronic blackboard 2b.

Then, the image processor 30 of the electronic blackboard 2b, in which the stroke processor 32 is provided, transmits the data of the stroke image (B) to the remote operation transmitter 65, so that the remote operation transmitter 65 of the electronic blackboard 2b transmits the data of the stroke image (B) to the communication controller 70 provided in the electronic blackboard 2a serving as the host apparatus via the communication network 9 (step S43).

Then, the remote operation receiver 75 of the electronic blackboard 2a receives the data of the stroke image (B) and outputs the received image data to the remote operation processor 83, so that the remote operation processor 83 outputs the data of the stroke image (B) to the operation synthesis processor 84. In this way, each time a stroke is drawn on the electronic blackboard 2b, data of the stroke image (B) are sequentially transmitted to the remote operation processor 83 of the electronic blackboard 2a serving as the host apparatus. Here, data of the stroke image (B) correspond to data represented by each stroke data ID as illustrated in Table 2. For example, as explained in the above description, in a case where a user draws an alphabet letter “T” using the electronic pen 4, data of the stroke image (B) represented with each of the two stroke IDs are sequentially transmitted as the alphabet letter “T” is written with two strokes.

Then, the electronic blackboard 2a serving as the host apparatus displays on the display 3a the superimposed image (A, B, C) including the data of the stroke image (B) transmitted from the electronic blackboard 2b (step S44). Specifically, the operation synthesis processor 84 of the electronic blackboard 2a synthesizes multiple sets of data of the stroke images (B) sequentially transmitted from the remote operation processor 83, stores the synthesized data in the operation data storage 840, and then returns the synthesized data to the remote operation processor 83. Then, the remote operation processor 83 outputs the synthesized data of the stroke images (B) received from the operation synthesis processor 84 to the remote operation transmitter 76. The remote operation transmitter 76 outputs the synthesized data of the stroke images (B) to the remote operation receiver 66 provided in the client unit 20 of the same electronic blackboard 2a serving as the host apparatus. The remote operation receiver 66 outputs the synthesized data of the stroke images (B) to the display superimposer 36 provided in the image processor 30. Then, the display superimposer 36 superimposes the synthesized data of the stroke images (B) on the UI image (A) and the output image (C). Then, the video superimposer 28 displays the superimposed image (A, B, C) generated by the display superimposer 36 on the display 3a.

Then, the communication controller 70, in which the remote operation transmitter 76 is provided, of the server unit 90 of the electronic blackboard 2a serving as the host apparatus transmits the synthesized data of the stroke images (B) via the communication network 9 to the communication controller 60 provided in the other electronic blackboard 2c, not the electronic blackboard 2b which is the sender of the data of the stroke images (B) (step S45). In this way, the remote operation receiver 66 provided in the electronic blackboard 2c serving as one of the participating apparatuses receives the synthesized data of the stroke images (B).

Then, the electronic blackboard 2c displays the superimposed image (A, B, C) on the display 3c (step S46). Specifically, the remote operation receiver 66 provided in the electronic blackboard 2c outputs the synthesized data of the stroke images (B) received in step S45 as described above to the image processor 30 of the electronic blackboard 2c. The display superimposer 36 provided in the image processor 30 superimposes the synthesized data of the stroke images (B) on the data of the UI image (A) and the output image (C), and then the outputs the data of the superimposed image (A, B, C) to the video superimposer 28. In this way, the superimposed image (A, B, C) is displayed on the display 3c.

Here, although a superimposed image including the output image (C) is displayed on the display 3 in the above processing, a superimposed image including the background image (D) may be displayed alternatively. Further, instead of displaying a superimposed image including either the output image (C) or the background image (D), a superimposed image including both the output image (C) and the background image (D) may be displayed on the display 3 at the same time.

(Participation Termination)

In the following, processing for a participating apparatus to terminate remote-sharing processing is described, with reference to FIG. 10. In FIG. 10, the electronic blackboard 2c terminates participation in the remote-sharing processing.

First, responding to a request for terminating participation through a user operation using an input unit such as a touch panel, the remote participation processor 62 transmits a request for terminating participation to the connection controller 70 provided in the server unit 90 of the electronic blackboard 2a serving as the host apparatus (step S47). In this way, the remote connection request receiver 71 provided in the communication controller 70 of the electronic blackboard 2a receives the request for terminating participation from the electronic blackboard 2c, and then outputs the request for terminating participation to the remote connection processor 81 along with the IP address of the electronic blackboard 2c. Then, based on the IP address of the electronic blackboard 2c transmitted from the remote connection request receiver 71, the remote connection processor 81 provided in the electronic blackboard 2a deletes from the participating location management table 820 the IP address of the electronic blackboard 2c which is the sender of the request for terminating participation and the name of the location of the electronic blackboard 2c. Then, the remote connection processor 81 outputs a notification of the deletion of the IP address of the electronic blackboard 2c to the remote connection result transmitter 72 provided in the electronic blackboard 2a.

Then, the communication controller 70, in which the remote connection result transmitter 72 is provided, sends an instruction for terminating participation to terminate participation via the communication network 9 to the communication controller 60 provided in the client unit 20 of the electronic blackboard 2c (step S48). In this way, the remote participation processor 62 provided in the communication controller 60 of the electronic blackboard 2c disconnects the communication of the remote-sharing processing, so as to terminate participation (step S49).

### First Embodiment

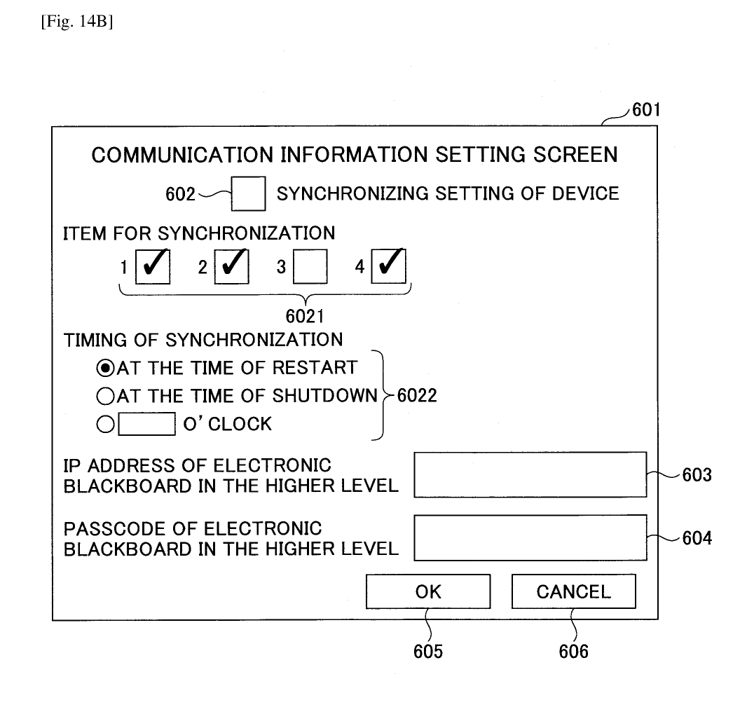

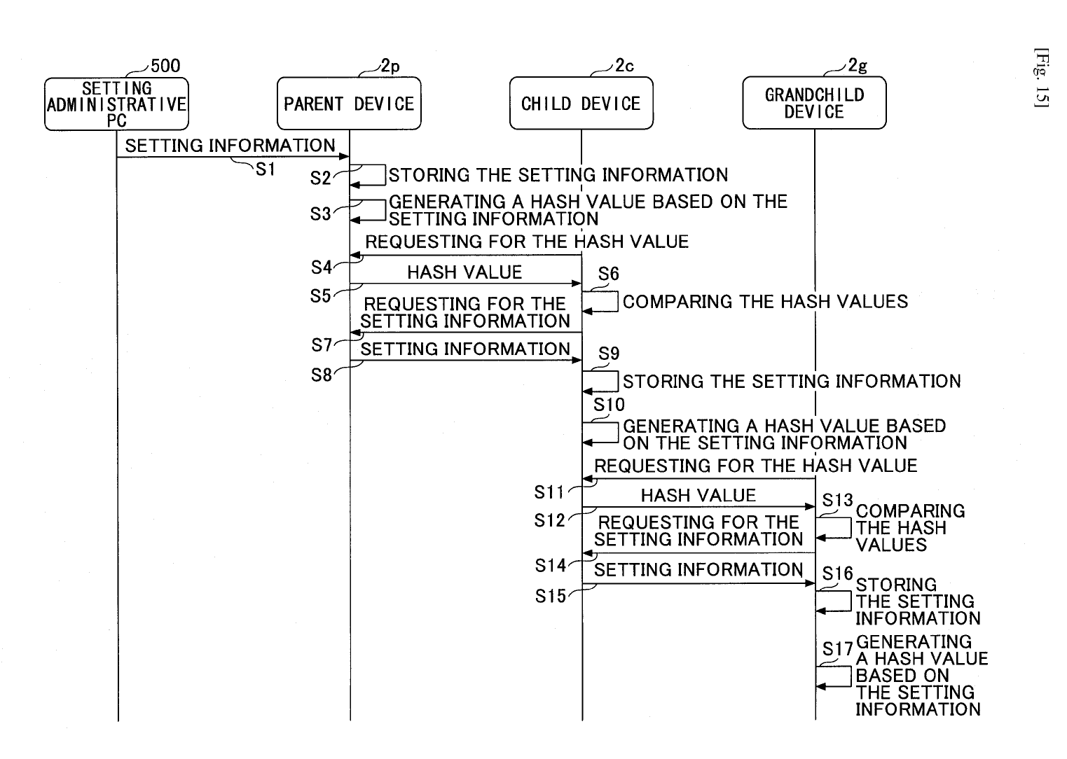

In the first embodiment, the image processing system 1 will be described. The image processing system 1 has a tree network configuration in which an electronic blackboard 2 in a lower level performs a process of acquiring setting information from an electronic blackboard 2 in the higher level, and the process is repeatedly performed between each of the electronic blackboards 2 in a lower level and each of the electronic blackboards 2 in a higher level, so as to synchronize the setting information. Here, setting information, which will be described in detail along with FIG. 14A, etc., is information indicative of settings relating to operation of the electronic blackboards 2, such as a setting for proper operation of the electronic blackboards 2, a setting for permitting or restricting operation of the electronic blackboards 2, an ON/OFF setting for each function, and a setting for communicating with other devices or connecting to the Internet through a network.

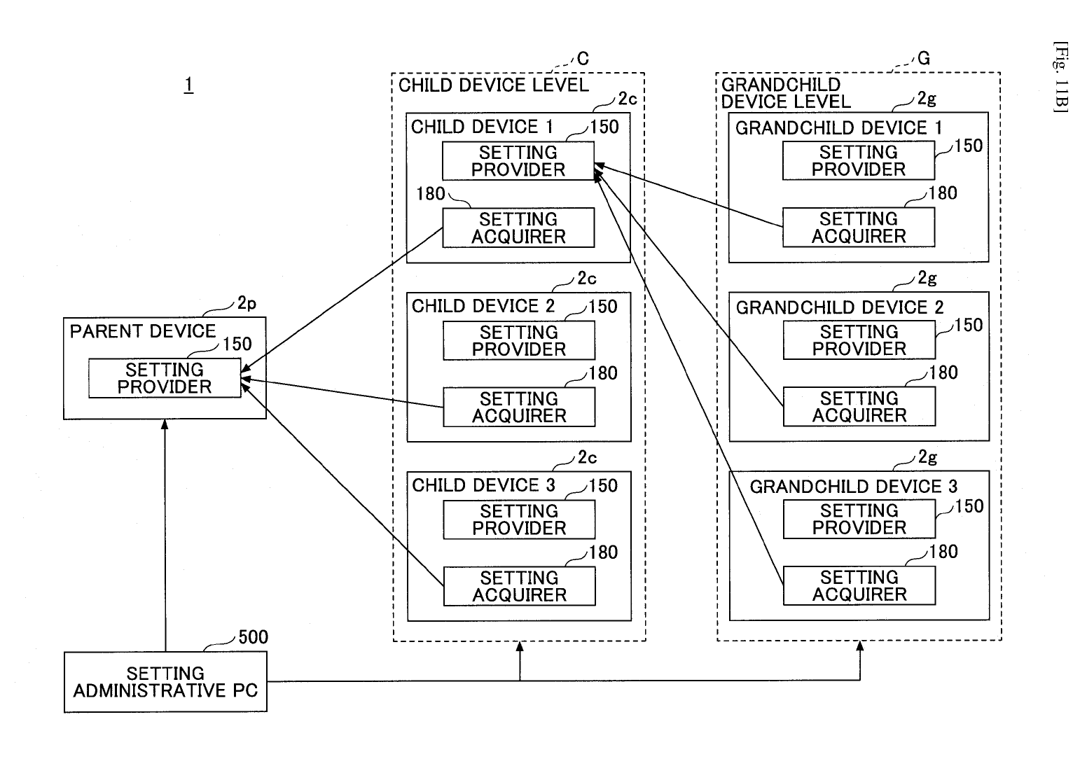

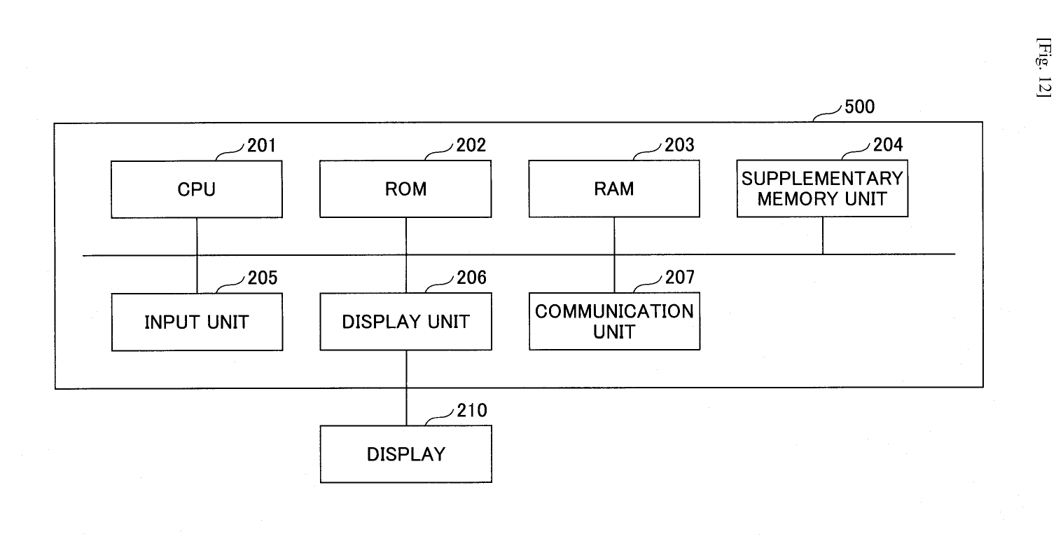

FIGS. 11A and 11B are drawings illustrating examples of the network configuration of the image processing system 1 and functions operated on each of the electronic blackboard 2 at the time of performing setting of setting information. The electronic blackboards 2 are mutually connected via the communication network 9. Here, the network configuration with multiple levels illustrated in FIG. 11A is only associated with synchronization of setting information, and therefore each of the electronic blackboards 2 is capable of communicating with the other multiple electronic blackboards 2 for transmission of image data, etc. However, the processing for synchronization of setting information according to the first embodiment is performed in the tree network configuration as illustrated in FIG. 11A. Here, the each of the electronic blackboards in a higher level and in a lower level may be connected via a universal serial bus (USB) cable, instead of the communication network 9, or may be connected with wire or wireless.

A setting administrative personal computer (PC) 500 illustrated in FIG. 11A is a PC operated by a setting administrator. The setting administrator operates the setting administrative PC 500 so as to perform setting of setting information (described hereinafter) on the parent device 2p. Once setting information is set on the parent device 2p, all of the electronic blackboards 2 in the child device level C and the grandchild device level G synchronize with the parent device 2p, so that the same setting information is set on all of the electronic blackboards 2 in the child device level C and the grandchild device level G.

The setting administrative PC 500 may run browser software so as to communicate with the parent device 2p and acquire screen information written in HTML or JavaScript (registered trademark). Then, the setting administrative PC 500 displays a setting information setting screen, which will be described hereinafter. Here, the setting administrator may select and enter setting information.

Furthermore, the setting administrator may operate the setting administrative PC 500, so as to perform setting of communication information (described hereinafter) on the electronic blackboards 2 in the child device level C and the grandchild device level G. The communication information is information with which each of the electronic blackboards 2 in a lower level communicates with an electronic blackboard 2 in a higher level. For this purpose, the setting administrative PC 500 displays a communication information setting screen, which will be described hereinafter. Here, the setting administrator may select and enter communication information with which each of the electronic blackboards 2 in a lower level communicates with an electronic blackboard 2 in a higher level.

FIG. 11B is a schematic view illustrating an example of functions which operate on the parent device 2p, the child devices 2c, and the grandchild devices 2g. As illustrated in FIG. 11B, a setting provider 150 operates on the parent device 2p, whereas the setting provider 150 and a setting acquirer 180 operate on the child device 1. Here, the setting acquirer 180 provided on an electronic blackboard 2 in the child device level C operates for acquiring setting information from the parent device 2p, whereas the setting provider 150 provided on an electronic blackboard 2 in the child device level C operates in response to a request for setting information from an electronic blackboard 2 in the grandchild level G.

The setting acquirer 180 provided on an electronic blackboard 2 in the grandchild device level G operates for acquiring setting information from an electronic blackboard 2 in the child device level C. Supposing that there is a great-grandchild device level although not illustrated in the drawings, the setting provider 150 provided on an electronic blackboard 2 in the grandchild device level G operates in response to a request for setting information from an electronic blackboard 2 in the great-grandchild level.

FIG. 12 is a drawing illustrating an example of a hardware configuration of the setting administrative PC 500. The setting administrative PC 500 includes a central processing unit (CPU) 201, a read-only memory (ROM) 202, a random access memory (RAM) 203, and a supplementary memory unit 204. The setting administrative PC 500 further includes an input unit 205, a display unit 206, and a communication unit 207. Here, each unit included in the setting administrative PC 500 is mutually connected via a bus 208. Here, the setting administrative PC 500 has functions for serving as an information processing apparatus.

The CPU 201 executes programs stored in the supplementary memory unit 204 and an operating system (OS). The ROM 202 is a non-volatile memory. The ROM 202 stores programs, data, etc., utilized by the CPU 201 to execute the programs stored in the supplementary memory unit 204.

The RAM 203 is a main memory unit, such as a dynamic random access memory (DRAM) and a static random access memory (SRAM). The CPU 201 loads the programs stored in the supplementary memory unit 204 on the RAM 203, and then the RAM serves as a work area for the CPU 201 to execute the programs.

The supplementary memory unit 204 stores the programs to be executed by the CPU 201 and databases to be used by the CPU 201 to execute the programs. The supplementary memory unit 204 is a non-volatile memory, such as a hard disk drive (HDD) and a solid state drive (SSD). The databases will be described hereinafter.

The input unit 205 is an interface for an operator to enter instructions on the setting administrative PC 500, such as a keyboard, a mouse, a touch panel, and a voice-input device. The setting administrative PC 500 may further include a connection unit, such as a USB interface (I/F), to be connected by a recording medium.

The display unit 206 displays information stored in the setting administrative PC 500 on a display 210 by use of a cursor, a menu, a window, a letter, an image, etc., in response to a request from the CPU 201.

The communication unit 207 is a network I/F for communication with the electronic blackboards 2 via a network N.

<Functions of the Setting Provider 150>

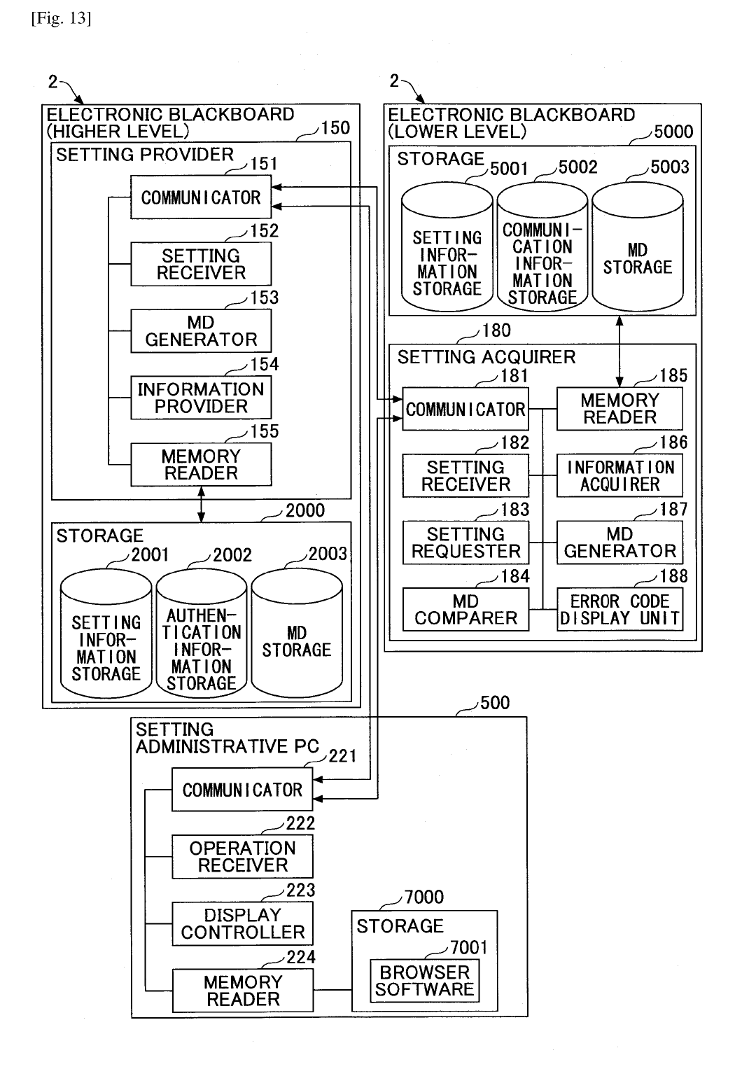

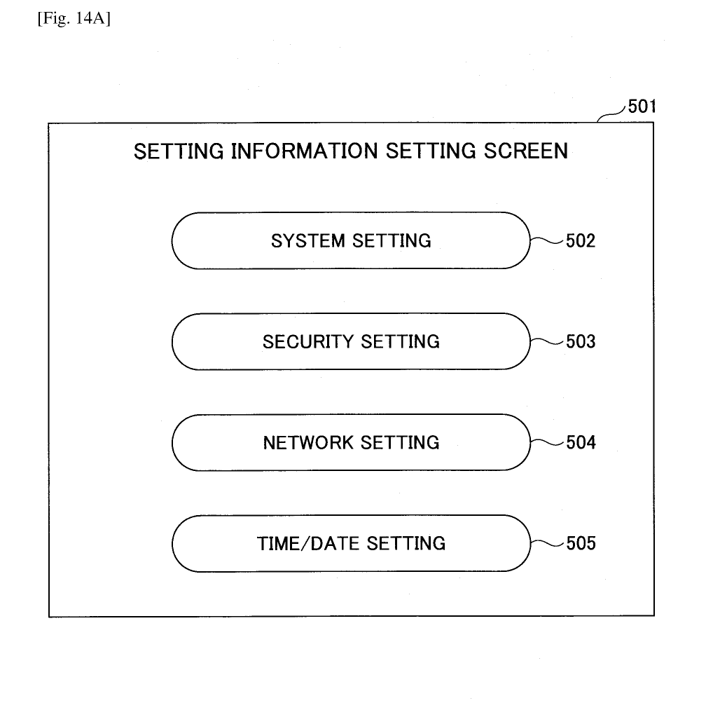

FIG. 13 is a functional block diagram illustrating examples of the setting acquirer 180 and the setting provider 150 in detail. Here, the setting provider 150 included in the electronic blackboard 2 in the lower level is not illustrated in the drawing as a matter of convenience in explanation. Similarly, the setting acquirer 180 included in the electronic blackboard 2 in the higher level is not illustrated in the drawing as a matter of convenience in explanation.

The setting provider 150 includes a communicator 151, a setting receiver 152, a message digest (MD) generator 153, an information provider 154, and a memory reader 155. Here, each of the functional units provides functions or methods as the CPU 101 executes programs stored in the SSD 104 and controls the relevant constituent parts illustrated in FIG. 4.

Further, the setting provider 150 is capable of accessing to storage 2000 which is constituted by at least one of the SSD 104, the ROM 102, and the RAM 103 illustrated in FIG. 4. The storage 2000 includes setting information storage 2001, authentication information storage 2002, and MD storage 2003. First, information stored in the storage 2000 will be described.

TABLE 11

| | |
|---|---|
| PASSCODE | * * * * * * * |

Table 11 illustrates an example of authentication information stored in the authentication information storage 2002. In Table 11, a passcode is registered as the authentication information. The electronic blackboard 2 in the higher level authenticates the electronic blackboard 2 in the lower level based on whether a passcode sent from the electronic blackboard 2 in the lower level matches the passcode stored in the authentication information storage 2002. Here, an electronic certificate may be applied as an authentication method, instead of using a passcode.

TABLE 12

| SETTING | SETTING INFORMATION | |
|---|---|---|
| INFORMATION TYPE | SETTING TIME | FILE NAME |
| OPERATION OF | 2015/03/01 14:15:32 | set-valid |
| DEVICE | | |

Table 12 illustrates an example of setting information stored in the setting information storage 2001. In Table 12, setting information type, setting information setting time, and file name are registered. The setting information for operation of device indicates currently active setting information. The setting information setting time indicates time and date on which the setting information is set on the electronic blackboard 2. The file name indicates the name of a file storing the setting information.

TABLE 13

| SETTING | |
|---|---|
| INFORMATION TYPE | HASH VALUE |
| OPERATION OF | . . . |
| DEVICE | |

Table 13 illustrating an example of a hash value (i.e. MD) stored in the MD storage 2003. The MD storage 2003 stores an MD of the setting information for operation of device. A hash value is commonly used as an MD, although an MD may be other information that changes along with even a small change of the setting information. Upon setting of setting information on an electronic blackboard 2, the electronic blackboard 2 generates a hash value from the setting information and then stores the hash value in the MD storage 2003. The hash value is used by an electronic blackboard 2 in the lower level for determining the need for synchronizing setting information.

<Function of the Setting Provider 150>

The communicator 151, which is implemented by the CPU 101 and the network controller 105, etc., illustrated in FIG. 4, transmits and receives information to and from the electronic blackboard 2 in the lower level and the setting administrative PC 500. For example, the communicator 151 transmits screen information indicative of the setting information setting screen to the setting administrative PC 500 and transmits the setting information to the electronic blackboard 2 in the lower level. Here, communication protocol may be, but not limited to, Hyper Text Transfer Protocol (HTTP), HTTP/2, SPDY, etc. In the following explanation, with regard to such a description as “the setting provider 150 communicates with the setting acquirer 180 via the communicator 151”, the description “via the communicator 151” may be omitted.

The setting receiver 152, which is implemented by the CPU 101, etc., illustrated in FIG. 4, functions as a web server or a web application and generates screen information indicative of the setting information setting screen in a form of HTML or JavaScript (registered trademark), which is sent to the setting administrative PC 500.

The MD generator 153, which is implemented by the CPU 101, etc., illustrated in FIG. 4, generates an MD from the setting information and stores the MD in the MD storage 2003 via the memory reader 155.

The information provider 154, which is implemented by the CPU 101, etc., illustrated in FIG. 4, provides the setting information to the electronic blackboard 2 in the lower level in response to a request from the electronic blackboard 2 in the lower level.

The memory reader 155, which is implemented by CPU 101, SSD 104, RAM 103, etc., performs read and write processing of information to the storage 2000. In the following explanation, with regard to such a description as “the setting provider 150 performs read and write processing of information to the storage 2000 via the memory reader 155”, the description “via the memory reader 155” may be omitted.

<Functions of the Setting Acquirer 180>

The setting acquirer 180 includes a communicator 181, a setting receiver 182, a setting requester 183, an MD comparer 184, a memory reader 185, an information acquirer 186, an MD generator 187, and an error code display unit 188. Here, each of the functional units provides functions or methods as the CPU 101 executes programs stored in the SSD 104 and controls the relevant constituent parts illustrated in FIG. 4.

Further, the setting acquirer 180 is capable of accessing to a storage 5000 which is constituted by at least one of the SSD 104, the ROM 102, and the RAM 103 illustrated in FIG. 4. The storage 5000 includes setting information storage 5001, communication information storage 5002, and MD storage 5003. Similarly to the electronic blackboard 2 in the higher level, setting information is stored in the setting information storage 5001 and an MD (i.e. hash value) is stored in the MD storage 5003.

TABLE 14A

| | |
|---|---|
| IP ADDRESS | 192.168.1.1 |
| (ELECTRONIC BLACKBOARD | |
| IN THE HIGHER LEVEL) | |
| PASSCODE | * * * * * * * |
| (ELECTRONIC BLACKBOARD | |
| IN THE HIGHER LEVEL) | |

TABLE 14B

| | |
|---|---|
| SYNCHRONIZATION | ON |
| TIMING OF SYNCHRONIZATION | AT THE TIME OF RESTART |
| ITEMS TO BE SYNCHRONIZED | ITEM NUMBER 1,2,4 |

Table 14A illustrates an example of the communication information stored in the communication information storage 5002. The communication information is used by the electronic blackboard 2 in the lower level for communicating with the electronic blackboard 2 in the higher level. In the first embodiment, an Internet Protocol (IP) address and a passcode are stored as the communication information. The communication information is set on each of the electronic blackboards 2 (except for electronic blackboards serving as the parent device) by the setting administrator through an operation of the setting administrative PC 500, as described hereinafter. Based on such a tree network configuration having multiple levels (three levels or more) as illustrated in FIG. 11A, the setting administrator sets an IP address and a passcode for connecting to the electronic blackboard 2 in the higher level of each of the electronic blackboards 2. Here, the illustrated communication information is just an example and may include a port number, etc.

Table 14B illustrates an example of synchronization information stored in the communication information storage 5002. The synchronization information is referred by the electronic blackboard 2 in the lower level to synchronize with the electronic blackboard 2 in the higher level. In the first embodiment, “SYNCHRONIZATION”, “TIMING OF SYNCHRONIZATION”, and “ITEMS TO BE SYNCHRONIZED” are registered as the synchronization information. “SYNCHRONIZATION” is turned ON so that synchronization is performed and is turned OFF so that synchronization is not performed. “TIMING OF SYNCHRONIZATION” indicates the timing for the electronic blackboards 2 to perform synchronization. “ITEMS TO BE SYNCHRONIZED” is for setting items to be synchronized, among multiple items included in the setting information, using numbers assigned to each of the items. “TIMING OF SYNCHRONIZATION” may be immediately after shutdown, at a predetermined time (such as at four o'clock everyday), etc., other than at the time of restart.

<Functions of the Setting Acquirer 180>

The communicator 181, which is implemented by the CPU 101, the network controller 105, etc., illustrated in FIG. 4, transmits and receives information to and from the electronic blackboard in the higher level and the setting administrative PC 500. For example, the communicator 181 transmits screen information indicative of a communication information setting screen to the setting administrative PC 500, and receives setting information from the electronic blackboard 2 in the higher level. Here, the communication protocol may be, but not limited to, HTTP, HTTP/2, SPDY, etc. In the following explanation, with regard to such a description as “the setting acquirer 180 communicates with the setting provider 150 via the communicator 181”, the description “via the communicator 181” may be omitted.

The setting receiver 182, which is implemented by the CPU 101, etc., illustrated in FIG. 4, functions as a web server or a web application and generates screen information indicative of the communication information setting screen in a form of HTML or JavaScript (registered trademark), which is sent to the setting administrative PC 500.

The setting requester 183, which is implemented by the CPU 101, etc., illustrated in FIG. 4, performs synchronizing setting information with the electronic blackboard in the higher level at a predetermined timing. The timing is predetermined on the setting of the synchronization information illustrated in Table 14B. When communication is started, the setting requester 183 acquires a hash value from the electronic blackboard 2 in higher level.

The MD comparer 184, which is implemented by the CPU, etc., illustrated in FIG. 4, compares the hash value stored in the MD storage 5003 of the storage 5000 and the hash value acquired from the electronic blackboard 2 in the higher level.

The information acquirer 186, which is implemented by the CPU 101, etc., illustrated in FIG. 4, acquires setting information from the electronic blackboard 2 in the higher level in a case where the hash values are different according to the comparison result of the MD comparer 184. The setting information acquired via the memory reader 185 is stored in the setting information storage 5001 of the storage 5000.

After the setting information is stored in the setting information storage 5001 of the storage 5000 as setting information for operation of device, the MD generator 184, which is implemented by the CPU 101, etc., illustrated in FIG. 4, generates an MD from the setting information, and then stores the MD in the MD storage 5003 via the memory reader 185.

The error code display unit 188, which is implemented by the CPU 101, etc., illustrated in FIG. 4, displays an error code, etc., associated with synchronization processing of setting information on the display 3 or the setting administrative PC 500.

The memory reader 185, which is implemented by the CPU 101, the SSD 104, the RAM 103, etc., illustrated in FIG. 4, performs read and write processing of information to the storage 5000. In the following explanation, with regard to such a description as “the setting acquirer 180 reads and writes information stored in the storage 5000 via the memory reader 185”, the description “via the memory reader 185” may be omitted.

<Functions of the Setting Administrative PC 500>

The setting administrative PC 500 includes a communicator 221, an operation receiver 222, a display controller 223, and a memory reader 224. Here, each of the functional units provides functions or methods as the CPU 101 executes browser software 7001 stored in the supplementary memory unit 204 and controls the relevant constituent parts illustrated in FIG. 12.

Further, the setting administrative PC 500 is capable of accessing a storage 7000 which is constituted by at least one of the supplementary memory unit 204, the ROM 204, and the RAM 203 illustrated in FIG. 12. The storage 7000 stores the browser software 7001. Alternatively, the storage 7000 may store an application having substantially the same communication functions as the browser software 7001.

<Functions of the Setting Administrative PC 500>

The communicator 221, which is implemented by the CPU 201, the communicator 207, etc., illustrated in FIG. 12, transmits and receives information to and from the electronic blackboards 2. For example, the communicator 221 transmits setting information or communication information entered by the setting administrator.

The operation receiver 222, which is implemented by the CPU 201, the input unit 205, etc., illustrated in FIG. 12, receives operations from the setting administrator. Specifically, the operation receiver 222 receives input of setting information and communication information, etc.

The display controller 223, which is implemented by the CPU 201, the display unit 206, etc., illustrated in FIG. 12, displays the setting information setting screen and the communication information setting screen on the display 210. Specifically, the display controller 223 interprets screen information written in HTML, JavaScript (registered trademark), etc., which is sent from the electronic blackboards 2, so as to display a screen based on the screen information.

The memory reader 224, which is implemented by the CPU 201, the ROM 202, the RAM 203, etc., illustrated in FIG. 12, performs read and write processing of information from/to the storage 7000.

<Setting Information Setting Screen>

FIG. 14A is a drawing illustrating an example of a setting information setting screen 501 displayed on the display 210 of setting administrative PC 500. The setting information setting screen 501 includes a system setting button 502, a security setting button 503, a network setting button 504, and a time/date setting button 505. The setting administrator presses each button for performing detail settings. In the following, setting information corresponding to each button will be explained.

SYSTEM SETTING: settings of name of location, time until automatic shutout, time for automatic restart, time until automatic standby, etc., are performed.

SECURITY SETTING: settings of permitted/prohibited domain of email address (in a case of setting a domain as both permitted and prohibited domains, the domain is permitted), prohibition of direct input of email address, minimum digit of passcode, timing for generating passcode, hiding of passcode, etc., are performed. Here, “timing for generating passcode” is for setting the timing (e.g. at the time of startup) or time for generating a passcode, in a condition where a passcode is automatically generated by the electronic blackboards 2. That is to say, passcodes may be automatically generated by the electronic blackboards 2, or may be preset by the setting administrator.

NETWORK SETTING: settings of IP address, subnet mask, default gateway, domain name system (DNS), etc., are performed.

TIME/DATE SETTING: settings of time zone, synchronization with time server, etc., are performed.

In a condition where the timing for synchronization is at the time of restarting the electronic blackboard 2, the setting administrator sets the timing for synchronization using the setting of time for automatic restart stored as the SYSTEM SETTING. Alternatively, the setting administrator may set a predetermined time as the timing for synchronization. As the timing for synchronization is stored as the SYSTEM SETTING and shared with each of the electronic blackboards 2, each of the electronic blackboards 2 in a lower level can acquire setting information from an electronic blackboard 2 in a higher level at the same timing.

Here, as only examples of the setting information are illustrated in FIG. 14A, the setting administrator may perform setting of a number of other items. Although information that may be set through the setting information setting screen 501 is generally handled as setting information, information preferred not to be synchronized may be exceptionally excluded from items for synchronization. For example, although NETWORK SETTING includes settings of an IP address and a subnet mask, the IP address is excluded from items for synchronization so as to prevent synchronizing the same IP address on all of the electronic blackboards 2. Further, the subnet mask may also be excluded from items for synchronization as the subnet mask also may not be the same on every electronic blackboard 2.

The setting administrative PC 500 receives entry of setting information and sends the setting information to an electronic black board 2 transmitting the screen information to display the setting information setting screen 501. In such a way, the setting provider 150 registers the setting information in the setting information storage 2001.

Here, the setting receiver 152 provided on the electronic blackboard 2 in the higher level may display the setting information setting screen 501 illustrated in FIG. 14A on the display 3 of the electronic blackboard 2, so as to receive a setting entered by the setting administrator.

TABLE 15

| ITEM | | |
|---|---|---|
| NUMBER | ITEM | CONTENTS |
| 1 | SYSTEM | NAME OF LOCATION: AA OFFICE |
| | SETTING | TIME UNTIL AUTOMATIC SHUTOUT: 1 HOUR |
| | | TIME FOR AUTOMATIC RESTART: A.M. 4 |
| | | TIME UNTIL AUTOMATIC STANDBY: 20 MINUTES |
| 2 | SECURITY | PERMITTED DOMAIN: aaa.co.jp |
| | SETTING | PROHIBITED DOMAIN: bbb.co.jp |
| | | PROHIBITION OF INPUT OF EMAIL ADDRESS: ON |
| | | MINIMUM DIGIT OF PASSCODE: 4 |
| | | TIMING FOR GENERATING PASSCODE: ONCE A MONTH |
| | | HIDING PASSCODE: OFF |
| 3 | NETWORK | IP ADDRESS: 192.168.2.1 |
| | SETTING | SUBNET MASK: 255.255.255.0 |
| | | DEFAULT GATEWAY: 192.168.2.0 |
| | | DNS: 192.168.2.0 |
| 4 | TIME/DATE | TIME ZONE: UTC + 9 |
| | SETTING | SYNCHRONIZATION WITH TIME SERVER: ON |

In table 15, a schematic example of contents of setting information set by the setting administrator is illustrated. In Table 15, an item and contents are registered, corresponding to each of the item numbers.

<Communication Information Setting Screen>

FIG. 14B is a drawing illustrating an example of a communication information setting screen 601 displayed on the setting administrative PC 500. On the communication information setting screen 601, a checkbox 602 along with a message “SYNCHRONIZING SETTING OF DEVICE” is displayed. The setting administrator checks the checkbox 602, so that the electronic black board 2 in the lower level performs synchronization of setting information with the electronic black board 2 in the higher level. Here, the checkbox 602 of the parent device 2p is not checked.

When the checkbox 602 is checked, settings of an item for synchronization 6021 and a timing of synchronization 6022 are allowed to the setting administrator. On the field of the item for synchronization 6021, the item numbers as illustrated in Table 14B and Table 15 are displayed so that each of the items is selectable. On the field of the timing of synchronization 6022, “at the time of restart”, “at the time of shutdown”, and a time setting area are displayed so as to be selectable.

The setting performed through the checkbox 602 is reflected on “SYNCHRONIZATION” of the setting of Table 14B. The setting performed through the item for synchronization 6021 is similarly reflected on “ITEMS TO BE SYNCHRONIZED”. The setting performed through the timing of synchronization 6022 is similarly reflected on “TIMING OF SYNCHRONIZATION”.

Further, an IP address entry field 603 and a passcode entry field 604 are displayed on the communication information setting screen 601. The setting administrator enters the IP address of the electronic blackboard 2 in the higher level is on the communication information setting screen 601 displayed through the electronic blackboard 2 in the lower level. Similarly, the setting administrator enters a passcode on the passcode entry field 604.

The setting administrator presses an OK button 605 to execute the setting of communication information on the electronic blackboard 2, and presses a CANCEL button 606 to abandon the setting of communication information on the electronic blackboard 2. The setting administrative PC 500 receives an entry of setting, and then transmits the entry to the electronic blackboard 2 transmitting the screen information for displaying the communication information setting screen 601. In such a way, the setting acquirer 180 registers the communication information on the communication information storage 5002.

Here, the setting receiver 182 provided on the electronic blackboard 2 in the lower level may display the communication information setting screen 601 as illustrated in FIG. 14B on the display 3 of the electronic blackboard 2, so as to receive a setting entry from the setting administrator.

<Sequence of Synchronization>

FIG. 15 is a sequence diagram illustrating a sequence performed in the image processing system 1 for synchronizing setting information. Here, a sequence performed by one of the child devices 2c in the child device level C and one of the grandchild devices 2g in the grandchild device level G is described in FIG. 15.

S1 (FIG. 15): as described above, the setting administrator operations the setting information setting screen 501 so as to perform setting of setting information on the parent device 2p.

S2 (FIG. 15): the setting receiver 152 provided on the parent device 2p receives the setting information, and then stores the setting information in the setting information storage 2001 as setting information for operation of device. Here, the setting information setting time is updated.

S3 (FIG. 15): the MD generator 153 provided on the parent device 2p generates an MD (hash value) based on the setting information for operation of device, and then stores the MD in the MD storage 2003. Here, the parent device 2p is ready to send the MD (hash value) to the child device 2c.

S4 (FIG. 15): upon detecting the need for synchronizing setting information based on, for example, an event of restarting the electronic blackboard 2, the setting requester 183 provided on the child device 2c starts communication with the parent device 2p having the IP address stored in the communication information storage 5002 so as to send a passcode to the parent device 2p as a login operation. In response to an approval for login, the setting requester 183 requests to provide the hash value.

Further, the electronic blackboards 2 of the parent device 2p and the child device 2c need to operate in mutually compatible synchronization sequences. Here, such a synchronization sequence is referred to as protocol. Protocol has versions, and the parent device 2p and the child device 2c preferably perform processing using the same version of protocol. Therefore, the hash value is sent to the child device 2c in a case where the versions of the protocols and the passcodes match. In the process of step S4 of FIG. 15, the versions of protocols and the passcodes match.

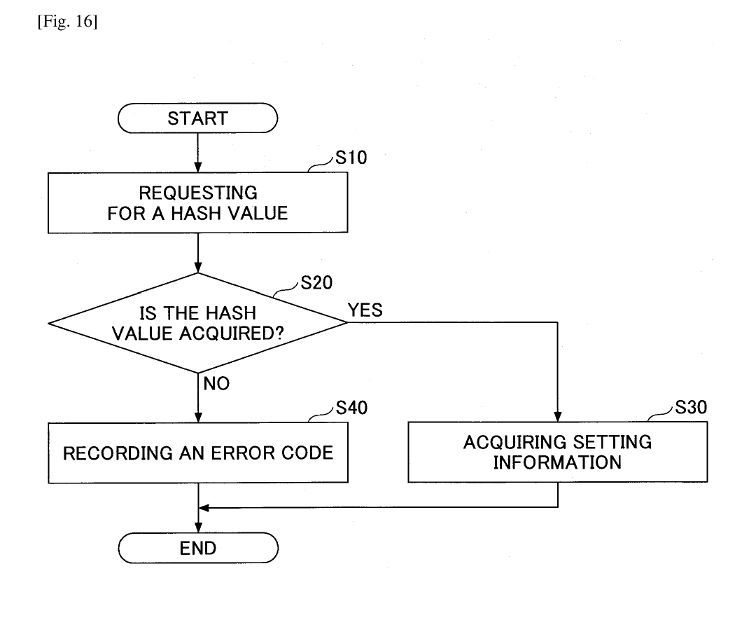

Further, needless to say, the child device 2c may not acquire the hash value in such a case where the power of the parent device 2p is off or the parent device 2p has some trouble. In an event of such a failure of acquiring the setting information from the parent device 2p, the setting requester 183 provided on the child device 2c records an error, which will be described in detail with reference to FIG. 16.

S5 (FIG. 15): the communicator 151 provided on the parent device 2p sends the MD (hash value) stored in the MD storage 2003 to the child device 2c.

S6 (FIG. 15): the setting requester 183 provided on the child device 2c receives the MD (hash value), and then the MD comparer 184 compares the hash value received from the parent device 2p and the hash value stored in the MD storage 5003. Comparing hash values needs smaller communication load than comparing the entire setting information. Here, a case where the hash values do not match is explained. When the hash values do not match, it is indicated that the setting information for operation of device in the parent device 2p has been updated (newer than the setting information in the child device 2c). Instead of hash values, serial numbers of setting information may be compared. In such a case, the parent device 2p or the setting administrator assigns a serial number to setting information, and the child device 2c synchronizes the serial number at the time of synchronizing the setting information. In a case where the serial numbers do not match, the child device 2c determines that the setting information of the parent device 2p has been updated. Alternatively, the setting information may be simply compared. In such a case, the child device 2c may update the setting information when the setting information in the parent device 2p and the setting information in the child device 2c do not match.

Here, the parent device 2p may acquire the hash value from the child device 2c for comparison. Although, in such a case, the load imposed on the parent device 2p increases, the parent device 2p may perform comparison if comparing hash values is not considered to impose too much load on the parent device 2p.

S7 (FIG. 15): in the case where the hash values do not match, the information acquirer 186 provided on the child device 2c requests the parent device 2p to provide the setting information. As the setting information is not requested in a case where the hash values match, the loads imposed on the parent device 2p and the child device 2c are reduced.

S8 (FIG. 15): the communicator 151 provided on the parent device 2p sends to the child device 2c the setting information for operation of device retrieved from the setting information storage 2001.

S9 (FIG. 15): the communicator 181 provided on the child device 2c receives the setting information, and then the information acquirer 186 stores the setting information acquired from the parent device 2p in the setting information storage 5001 as setting information for operation of device. Then, the setting information setting time is updated.

S10 (FIG. 15): the MD generator 187 provided on the child device 2c generates a MD (hash value) from the setting information, and then stores the MD in the MD storage 5003. Here, the child device 2c is ready to send the MD (hash value) to the grandchild device 2g.

According to the processing described above, the setting information is synchronized between the parent device 2p and the child device 2c. Then, when the setting requester 183 provided on the grandchild device 2g detects the need for synchronizing setting information, the grandchild device 2g executes the same processing as the child device 2c, as illustrated in steps S11 through S17 (FIG. 15).

In such a way, each of the electronic blackboards 2 in a lower level only needs to perform update processing of setting information of itself, which causes less load imposed on each of the electronic blackboards 2, compared to a case where each of the electronic blackboards 2 in a higher level performs setting of the setting information on the respective multiple electronic blackboards 2 in a lower level.

Here, the grandchild device 2g acquires setting information in a cycle after a cycle where the child device 2c acquires setting information. In other words, when the grandchild device 2g is restarted, the child device 2c will be on the process of synchronization, and therefore the grandchild device 2g does not determine the need for synchronization because the hash values match. Therefore, for example, in a case where the synchronization is performed once a day (i.e. the electronic blackboards 2 are restarted once a day), the grandchild device 2g acquires setting information a day later than the child device 2c. However, as synchronizations are performed at different timings, each of the electronic blackboards 2 need not perform both synchronization of itself and transmission of setting information to each of the electronic devices 2 in a lower level at the same time, which reduces the load imposed on each of the electronic blackboards 2. In case that the delay is not preferred, the setting administrator may set the electronic blackboards 2 to automatically restart multiple times a day or the user or the setting administrator may manually restart the electronic blackboards 2, etc.

<Operation sequence of the child device 2c>

FIG. 16 is a flowchart illustrating an example of a sequence performed by the electronic blackboard 2 in the lower level for updating setting information. In FIG. 16, step S4 of FIG. 15 is mainly described.

As described above, the setting requester 183 provided on the child device 2c requests the parent device 2p to provide a hash value (S10 of FIG. 16). In response to the request, the communicator 151 provided on the parent device 2p sends to the child device 2c either the hash value or an error code in accordance with the type of error. In such a way, the child device 2c acquires either the hash value or the error code.

The setting requester 183 provided on the child device 2c determines whether the hash value is acquired (S20 of FIG. 16). In a case where the hash value is acquired (YES in S20 of FIG. 16), the information acquirer 186 provided on the child device 2c acquires setting information as described above (S30 of FIG. 16).

In a case where the hash value is not acquired (NO in S20 of FIG. 16), the setting requester 183 provided on the child device 2c stores an error code in the storage 5000 (S40 of FIG. 16). Below are examples of error codes.

400: the versions of protocols do not match.

401: the passcodes do not match.

Further, in a case of receiving no response from the parent device 2p (because the power is off, etc.), the setting requester 183 provided on the child device 2c records an error code 402 which indicates that there is no response. Here, the error code display unit 188 may display an error code on the display 3 of the electronic blackboards 2 or the setting administrative PC 500.

(Displaying of an Error Code)

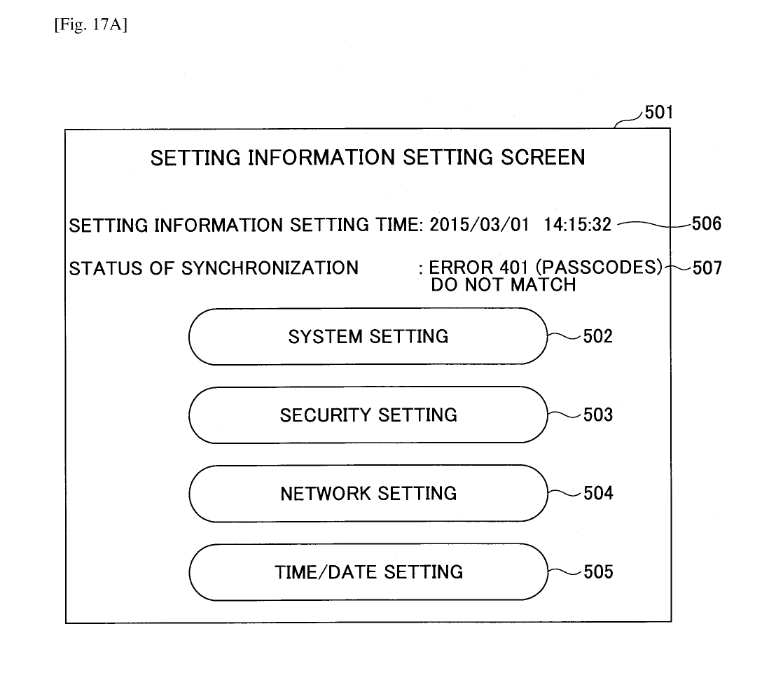

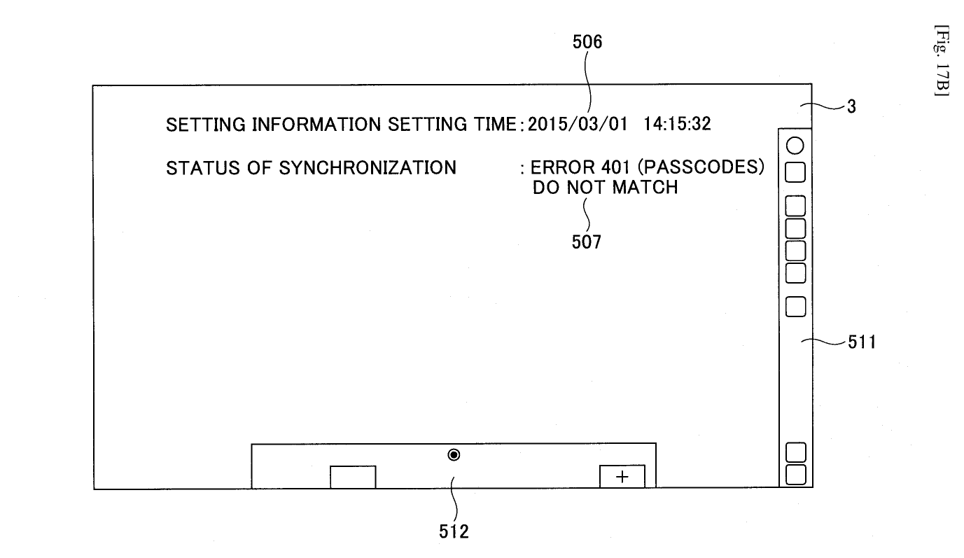

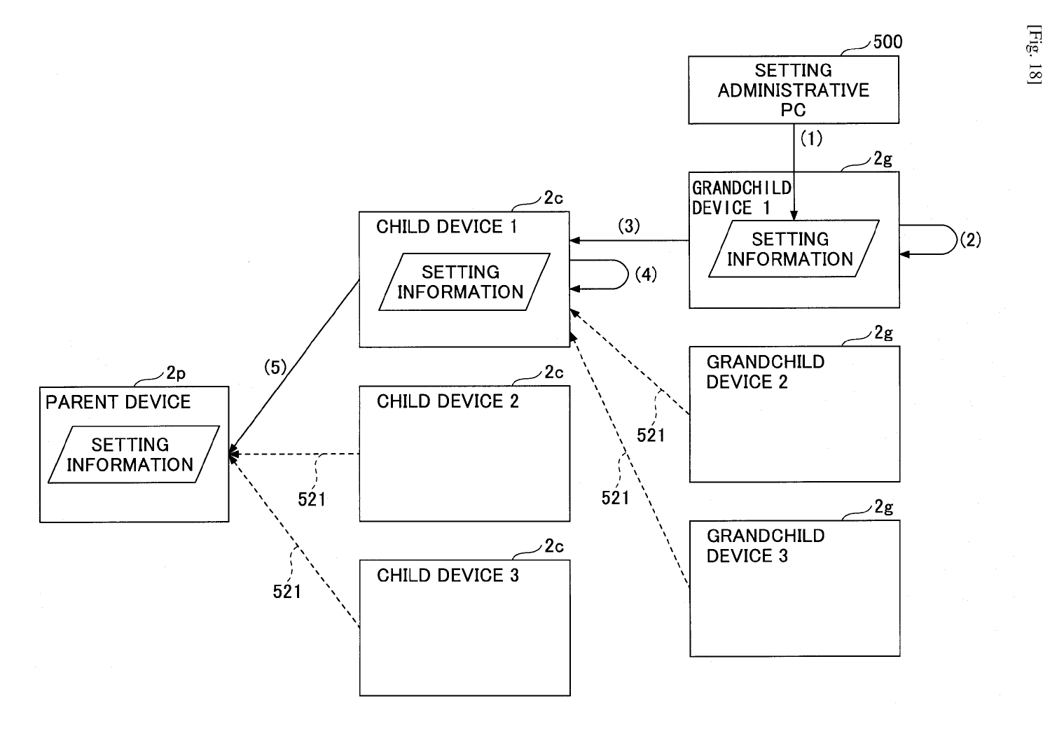

FIG. 17A is a drawing illustrating an example of the setting information setting screen 501 displayed on the display of the setting administrative PC 500. Here, differences from the description of FIG. 14 are mainly described with reference to FIG. 17A. The error code display unit 188 displays on the setting information setting screen 501 a status of synchronization 507 and a setting information setting time 506 stored in the setting information storage 5001. The setting administrator may understand a failure of synchronization according to a display of an error on the status of synchronization 507. Further, the setting administrator may understand the reason for the failure according to a display of an error code (and/or explanation of an error).

FIG. 17B is a drawing illustrating an example of an error code displayed on the display 3 of the electronic blackboard 2. The electronic blackboard 2 displays on the display 3 a tool icon field 511, which includes such tools as a handwriting tool and an eraser, and a page tool field 512, which is used for turning pages. Along with such fields, the error code display unit 188 provided on the electronic blackboard 2 displays the stratus of synchronization 507 and the setting information setting time 506 stored in the setting information storage 5001, for example, on the upper right corner of the display 3.

It is preferred that a display of an error code performed by the error code display unit 188 lasts just a couple seconds after a startup of the electronic blackboard 2, so as not to disturb the use of the electronic blackboard 2. The user may inform the setting administrator of a display of an error code, so that the setting administrator becomes aware of a failure of synchronization and the reason for the failure.

As described above, in the image processing system 1 according to the first embodiment, an electronic blackboard 2 in a lower level performs synchronization of setting information with an electronic blackboard 2 in a higher level, respectively, so as to synchronize the setting information with all of the electronic blackboards 2.

Here, instead of setting the setting information on the electronic blackboard 2 on top of the tree configuration, the setting administrator may set the setting information on an electronic blackboard 2 in a lower level. In such a case, synchronizations of the setting information are performed by the electronic blackboards 2 in the levels below the electronic blackboard 2 on which the setting administrator sets the setting information. Further, two or more parent devices 2p may be situated on the level of the parent device 2p. In such a case, the setting administrator sets the setting information on each of the two or more parent devices 2p.

### Second Embodiment

In the second embodiment, the image processing apparatus 1, in which the setting administrator may set the setting information on one of the electronic blackboards 2.

FIG. 18 is a drawing for schematically explaining synchronization of setting information in the image processing system 1 according to the second embodiment.

(1) First, the setting administrator operates the setting administrative PC 500 to perform setting of setting information, for example, on the grandchild device 1.

(2) The grandchild device 1 detects that setting of the setting information is performed.

(3) The grandchild device 1 sends the setting information to the child device 1 which is an electronic blackboard 2 registered above the grandchild device 1.

(4) The child device 1 detects that setting information is updated.

(5) The child device 1 sends the setting information to the parent device 2p which is an electronic blackboard 2 registered above the child device 1.

In such a sequence, the setting information is set on the child device 1 and the parent device 2p. Consequently, the grandchild devices 2 and 3 can synchronize the setting information with the child device 1, through the processes as described in the first embodiment (the processes are illustrated with dotted lines 521). Similarly, the child devices 2 and 3 can synchronize the setting information with the parent device 2p, through the processes as described in the first embodiment. Here, the setting information need not be synchronized between the parent device 2p and the child device 1, and between the child device 1 and the grandchild device, as the hash values match.

<Functions of the Setting Provider 150 and the Setting Acquirer 180>

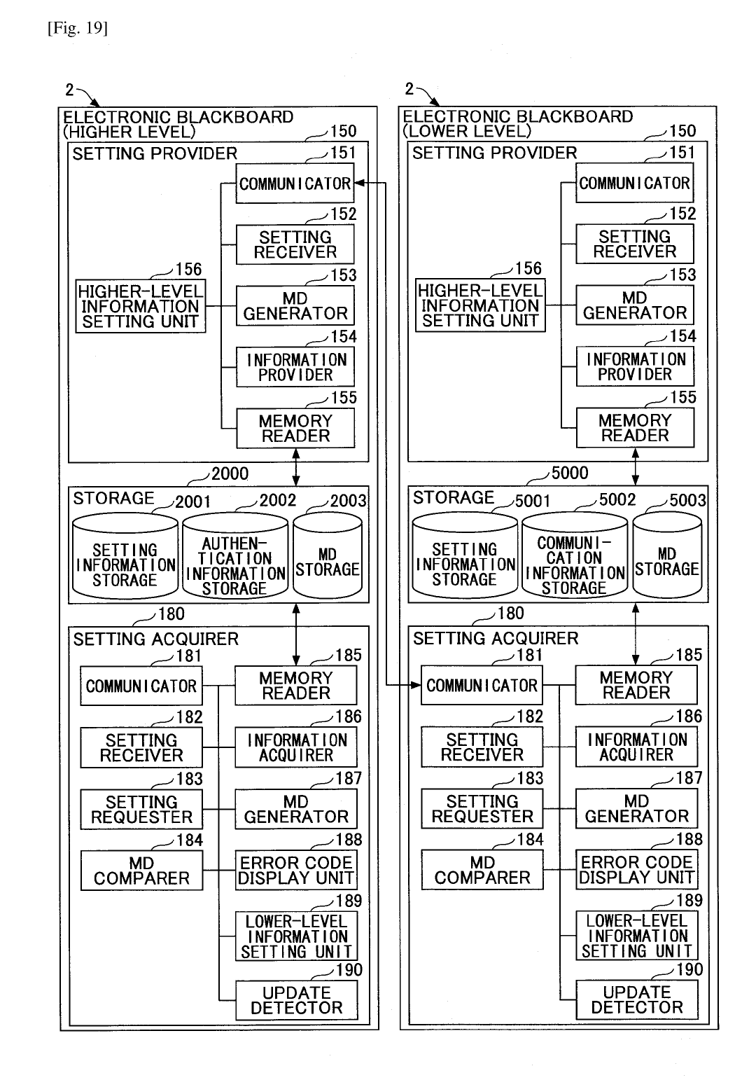

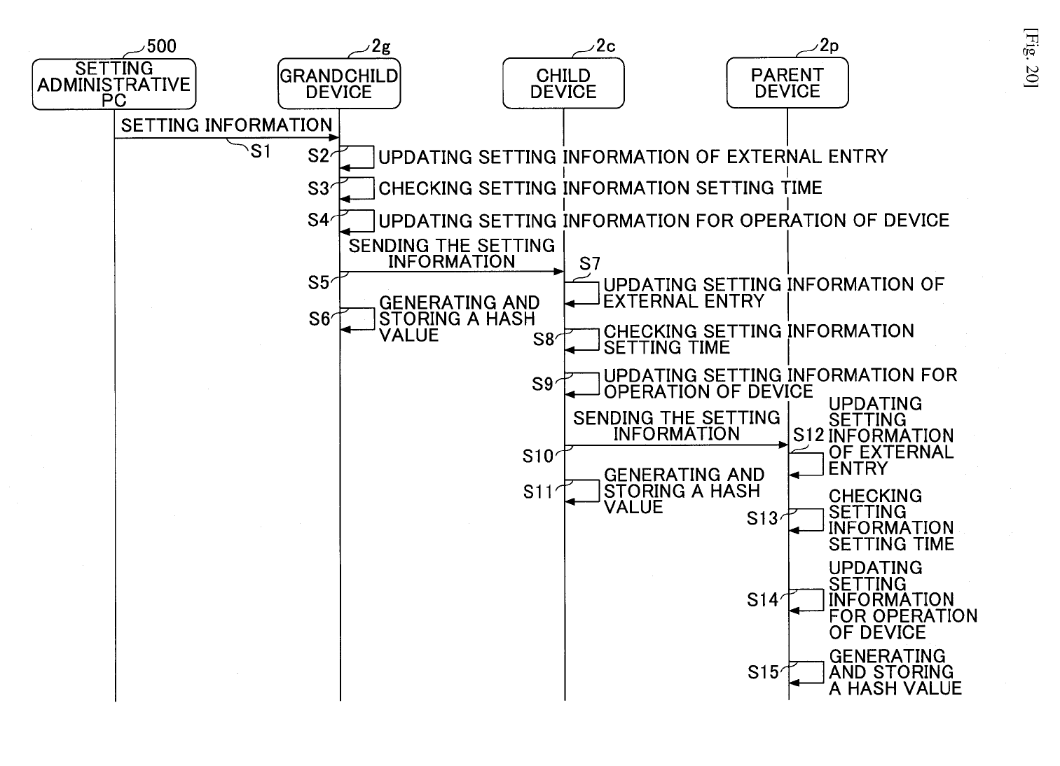

FIG. 19 is a functional block diagram illustrating examples of the setting provider 150 and the setting acquirer 180 according to the second embodiment. In FIG. 19, as the functions of constituent elements assigned with the same reference signs as in FIG. 13 are substantially the same, the explanations of such constituent elements described above may be omitted or only the differences may be explained.

In the second embodiment, the setting information stored in the setting information storages 2001 and 5001 are different from the setting information stored in the setting information storages 2001 and 5001 in the first embodiment.

TABLE 16

| SETTING | SETTING INFORMATION | |
|---|---|---|
| INFORMATION TYPE | SETTING TIME | FILE NAME |
| OPERATION OF | 2015/03/01 14:15:32 | set-valid |
| DEVICE | | |
| EXTERNAL ENTRY | 2015/03/01 14:15:32 | set-out |
| LOWER-LEVEL ENTRY | 2015/03/03 18:00:05 | set-low |

In Table 16, an example of the setting information stored in the setting information storages 2001 and 5001 is illustrated. Here, the differences between the Table 16 and Table 12 will be explained. In the second embodiment, the setting information storages 2001 and 5001 store setting information for operation of device, setting information of external entry, and setting information of lower-level entry. According to the second embodiment, setting information entered by the setting administrator is registered as setting information of external entry. Setting information sent from the electronic blackboard 2 in a lower level is registered as setting information of lower-level entry.

<Functions>

In the second embodiment, the setting receiver 152 provided on the electronic blackboard 2 in the lower level receives an entry of setting information. Here, the setting receiver 152 updates the setting information of external entry stored in the setting information storage 5001.

In the second embodiment, the setting acquirer 180 further includes a lower-level information setting unit 189 and an update detector 190. The update detector 190, which is implemented by the CPU 101, etc., illustrated in FIG. 4, detects an update of setting information stored in the setting information storage 5001. Specifically, the update detector 190 determines whether the setting information having the most recent setting information setting time is the setting information for operation of device. In a case where the setting information having the most recent setting information setting time is not the setting information for operation of device, the update detector 190 detects that either the setting information of external entry or the setting information of lower-level entry is updated.

Responding to a detection of an update performed by the update detector 190, the lower-level information setting unit 189 sends to the electronic blackboard 2 in the higher level the setting information (the setting information of external entry or the setting information of lower-level entry) which is determined to be different from the setting information for operation of device. The setting information may be sent from the setting acquirer 180 to the electronic blackboard 2 in the higher level, for example, at a predetermined timing for synchronization, although not limited to the predetermined timing.

The setting provider 150 further includes a higher-level information setting unit 156. The higher-level information setting unit 156, which is implemented by the CPU 101, etc., illustrated in FIG. 4, stores the setting information sent from the electronic blackboard 2 in the lower level in the setting information storage 2001 of the storage 2000 as setting information of lower-level entry.

Similarly, the update detector 190 provided on the electronic blackboard 2 in the higher level compares setting information for operation of device to setting information of external entry and setting information of lower-level entry, in order to detect an update of setting information. Then, the same processing is performed until reaching to the parent device 2p.

In such a way, an update of setting information may be detected based on setting information of external entry and setting information of lower-level entry stored in the setting information storage 2001 and 5001 before sending setting information from the electronic blackboard 2 in the lower level to the electronic blackboard 2 in the higher level. Here, an authentication method may be the same as in the first embodiment.

<Sequence of Synchronization>

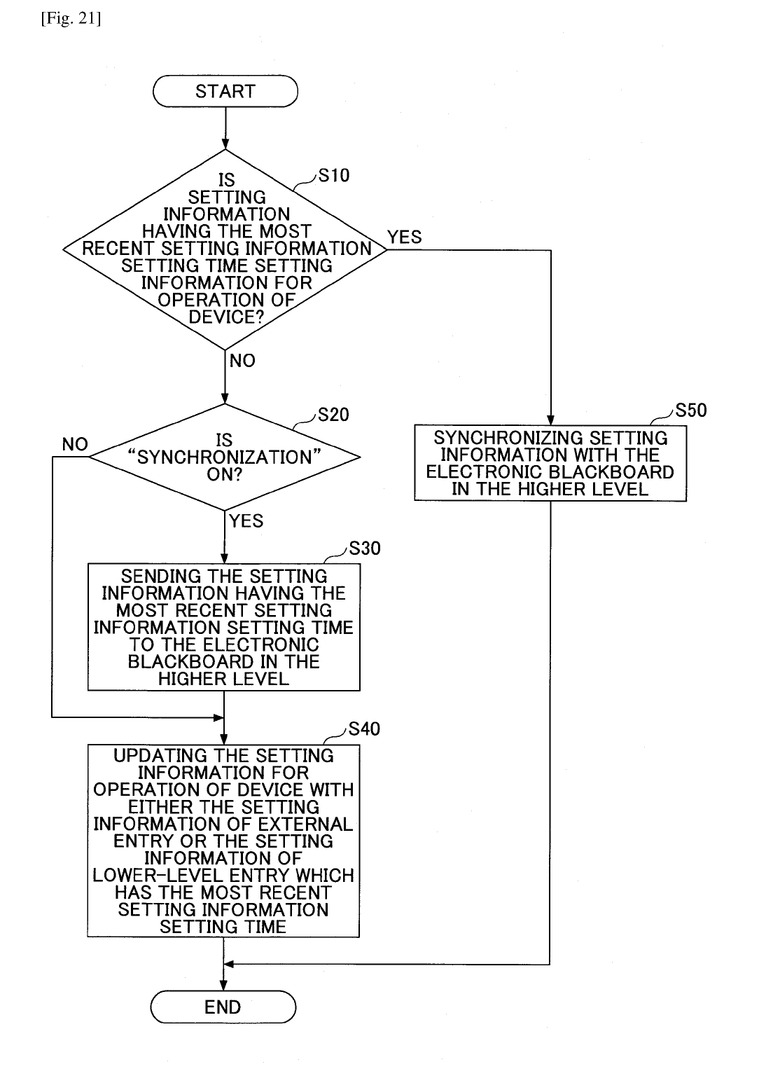

FIG. 20 is a sequence diagram illustrating an example of a sequence of synchronization of setting information performed in the image processing system 1. Here in FIG. 20, processing performed by one of the child devices 2c in the child device level C and one of the grandchild devices 2g in the grandchild level G will be explained. Further, the processing performed in each of the electronic blackboards 2 is illustrated in a flowchart of FIG. 21.

S1 (FIG. 20): as described above, the setting administrator operates the setting information setting screen 501 so as to perform setting of setting information on the grandchild device 2g.

S2 (FIG. 20): the setting receiver 152 provided included in the setting provider 150 provided on the grandchild device 2g receives the setting information, and then updates the information of external entry stored in the setting information storage 5001.

S3 (FIG. 20): the update detector 190 provided on the grandchild device 2g determines whether the setting information having the most recent setting information setting time is the setting information for operation of device. As the setting information for external entry has been updated, the setting information having the most resent setting information setting time is determined to be the setting information for external entry. In such a way, the electronic blackboard 2 can specify the setting information which is updated the most recently.

S4 (FIG. 20): upon detecting that the setting information is updated, the lower-level information setting unit 189 provided on the grandchild device 2g updates the setting information for operation of device with the setting information of external entry. As a record that the setting information of external entry has been updated, a flag is set on the setting information of external entry.

S5 (FIG. 20): upon detecting the need for synchronizing setting information based on, for example, an event of restarting the electronic blackboard 2, the lower-level information setting unit 189 provided on the grandchild device 2c detects that the setting information of external entry has been updated based on the flag, and then starts communication with the child device 2c having the IP address stored in the communication information storage 5002, so as to send the passcode to the child device 2c as a login operation. In a case where the login operation is successfully performed, the lower-level information setting unit 189 provided on the grandchild device 2g sends the setting information for operation of device to the child device 2c. Alternatively, the setting information of external entry to which the flag is attached may be sent. Upon sending either the setting information for operation of device or the setting information of external entry to the child device 2c, the lower-level information setting unit 189 deletes the flag.

Further, as the update of the setting information in the grandchild device 2g has been detected, there is no need to compare a hash value stored in the child device 2c and a hash value stored in the grandchild device 2g.

S6 (FIG. 20): further, the MD generator 187 included in the setting acquirer 180 provided on the grandchild device 2g generates a MD (hash value) based on the setting information for operation of device, and then stores the MD in the MD storage 2003. Here, the MD (hash value) is ready to be sent, upon a request from the electronic blackboard 2 in the lower level viewed from the grandchild device 2g.

In the following, the processing performed by the child device 2c will be explained. The processing performed by the child device 2c is almost the same as the processing performed by the grandchild device 2g.

S7 (FIG. 20): the higher-level information setting unit 156 provided on the child device 2c receives the setting information from the grandchild device 2g, and then updates the setting information of lower-level entry stored in the setting information storage 2001.

S8 (FIG. 20): the update detector 190 provided on the child device 2c determines whether the setting information having the most recent setting information setting time is the setting information for operation of device. As the setting information of lower-level entry has been updated, the setting information having the most recent setting information setting time is determined to be the setting information for lower-level entry. In such a way, the child device 2c detects an update of the setting information.

S9 (FIG. 20): upon detecting that the setting information has been updated, the lower-level information setting unit 189 provided on the child device 2c updates the setting information for operation of device with the setting information of lower-level entry. Further, a flag is set on the setting information of lower-level entry.

S10 (FIG. 20): upon detecting the need for synchronizing setting information based on, for example, an event of restarting the electronic blackboard 2, the lower-level information setting unit 189 provided on the child device 2c starts communication with the parent device 2p having the IP address stored in the communication information storage 5002, so as to send a passcode to the parent device 2p as a login operation. In a case where the login operation is successfully performed, the lower-level information setting unit 189 provided on the child device 2c sends the setting information for operation of device to the parent device 2p. Alternatively, the setting information of lower-level entry to which the flag is attached may be sent. Upon sending either the setting information for operation of device or the setting information of lower-level entry to the parent device 2p, the lower-level information setting unit 189 deletes the flag.

S11 (FIG. 20): further, the MD generator 187 included in the setting acquirer 180 provided on the child device 2c generates a MD (hash value) based on the setting information, and then stores the MD in the MD storage 2003. Here, the MD (hash value) is ready to be sent, upon a request from the electronic blackboard 2 in the grandchild device 2g.

In the following, the processing performed by the parent device 2p will be explained. The processing performed by the parent device 2p is almost the same as the processing performed by the child device 2c, except that the parent device 2p does not send setting information as there is no higher level above the parent device 2p. The electronic blackboard 2 serving as the parent device 2p does not perform synchronizations as the checkbox 602 on the communication information setting screen 601 of the electronic blackboard 2 serving as the parent device 2p is not checked (i.e. “SYNCHRONIZATION” of the synchronization information is OFF).

S12 (FIG. 20): the higher-level information setting unit 156 provided on the parent device 2p receives the setting information from the child device 2c, and then updates the setting information of lower-level entry stored in the setting information storage 5001.

S13 (FIG. 20): the update detector 190 provided on the parent device 2p determines whether the setting information having the most recent setting information setting time is the setting information for operation of device. As the setting information of lower-level entry has been updated, the setting information having the most recent setting information setting time is determined to be the setting information of lower-level entry.

S14 (FIG. 20): as the parent device 2p does not perform synchronization, upon detecting that the setting information of lower-level entry has been updated, the lower-level information setting unit 189 provided on the parent device 2p updates the setting information for operation of device with the setting information of lower-level entry. Therefore, there is no problem even though the setting administrator has performed setting of setting information on the parent device 2p just as in the first embodiment.

S15 (FIG. 20): further, the MD generator 187 provided included in the setting acquirer 180 provided on the parent device 2p generates a MD (hash value) based on the setting information, and then stores the MD in the MD storage 2003. Here, the MD (hash value) is ready to be sent, upon a request from the electronic blackboard 2 in the child device 2c.

As described above, the setting information is set on each of the grandchild device 2g, the child device 2c, and the parent device 2p. Subsequently, synchronizations are preformed between the parent device 2p and the child device 2c and between the child device 2c and the grandchild device 2g just as in the first embodiment. The information acquirer 186 provided on the electronic blackboard 2 in the lower level stores the setting information received from the electronic blackboard 2 in the higher level as the setting information for operation of device. Therefore, as the setting information having the most recent setting information setting time is the setting information for operation of device, the electronic blackboard 2 in the lower level does not send the setting information to the electronic blackboard 2 in the higher level while the synchronization processing according to the first embodiment is performed.

FIG. 21 is a flowchart illustrating processing performed by each of the electronic blackboards 2, responding to a detection of an update of setting information. The processing of FIG. 21 starts, for example, at the timing of performing synchronization.

First, the update detector 190 determines whether the setting information having the most recent setting information setting time is the setting information for operation of device (S10 of FIG. 21).

In a case where the determination in step S10 of FIG. 21 is YES, each of the electronic blackboards 2 performs synchronization with an electronic blackboard 2 in a higher level just as in the first embodiment (S50 of FIG. 21). In a case where the setting information has not been updated on each of the electronic blackboards 2 in a higher level, synchronization is not performed.

In a case where the determination in step S20 of FIG. 21 is NO, the lower-level information setting unit 189 determines whether the “SYNCHRONIZATION” of the synchronization information is ON (S20 of FIG. 21). In such a way, the lower-level information setting unit 189 determines whether the lower-level information setting unit 189 is provided on the electronic blackboard 2 on top of the tree configuration.

In a case where the “SYNCHRONIZATION” is ON (YES in S20 of FIG. 21), as there is an electronic blackboard 2 in the higher level, the lower-level information setting unit 189 sends the setting information having the most recent setting information setting time to the electronic blackboard 2 in the higher level (S30 of FIG. 21). In such a way, the setting information is sent from an electronic blackboard 2 in a lower level to an electronic blackboard 2 in a higher level until reaching to the electronic blackboard 2 on top of the tree configuration.

In a case where the “SYNCHRONIZATION” is OFF (NO in S20 of FIG. 21), as there are no electronic blackboards 2 above, the lower-level information setting unit 189 updates the setting information for operation of device with either the setting information of external entry or the setting information of lower-level entry which has the most recent setting information setting (S40 of FIG. 21). In such a way, the electronic blackboard 2 on top of the tree configuration operates according to the updated setting information.

Furthermore, the electronic blackboard 2 which sends the setting information to the electronic blackboard 2 in the higher level also operates according to the setting information updated through step S40.

In such a way, in the image processing system 2 according to the second embodiment, setting information is synchronized with all of the electronic blackboards 2 even though the setting administrator sets the setting information on any one of the electronic blackboards 2.

Further, the present invention is not limited to these embodiments, but various variations and modifications may be made without departing from the scope of the present invention.

Although setting information of electronic blackboards 2 is exemplified in the explanation of synchronization processing in the embodiments, such an update of setting information may be performed by devices other than the electronic blackboards 2. Such devices may be a projector, an image forming apparatus (a copier, a printer, a scanner device, a multi-function peripheral (MFP)), a teleconference device, etc.

Further, setting information is not limited to the examples of setting information for synchronization described in the embodiments. For example, the setting information may include a print setting associated with a printer connected to the electronic blackboard 2 (such as authentication for printing, password, and encryption), a setting of region and language, a setting relating to management of registration data (such as a setting for restricting read and write operations to information included in the electronic blackboard 2), a setting relating to color profiling, and user information of the electronic blackboard 2 (such as user name, address such as an email address to which the electronic blackboard 2 sends an email), etc. Further, in a case where devices other than electronic blackboards 2 are synchronized, information specific to the devices may be synchronized.

Further, the configurations exemplified in FIG. 13, FIG. 19, etc., are divided into units according to main functions of an electronic blackboard 2 in order to help understand the processing of the electronic blackboard 2. The present invention is not limited to the way of dividing into units or the name of each unit. The processing of the electronic blackboard 2 may be divided into even smaller units according to processing details. Furthermore, the processing of the electronic blackboard 2 may be divided into units so as to include a larger range of processing.

Further, one or more storage units included in the storages 2000 and 5000 illustrated in FIG. 13 and FIG. 19 may be disposed on the network.

Here, the setting receiver 152 is an example of a setting receiving unit. The setting information storages 2001 and 5001 are examples of setting information storing units. The communication information storage 5002 is an example of a communication information storing unit. The information acquirer 186 is an example of an acquiring unit. The MD generator 187 is an example of a generating unit. The setting requester 183 is an example of a message digest acquiring unit. The MD comparer 184 is an example of a determining unit. The setting administrative PC 500 is an example of an external device. The display 3 of the electronic blackboard 2 is an example of a display unit. The error code display unit 188 is an example of a display processing unit.

The setting information for operation of device is an example of setting information stored in a first region. The setting information of external entry and the setting information of lower-level entry are examples of setting information stored in a second region. The update detector 190 is an example of an update detecting unit. The lower-level information setting unit 189 is an example of an upward sending unit. The image processing system 1 is an example of a communication system.

For example, the parent device 2p viewed from the child device 2c is a first information processing apparatus. The electric blackboard 2 in the level immediately above the parent device 2p is another information processing apparatus. The grandchild device 2g viewed from the child device 2c is a second information processing apparatus. The setting receiver 182 is an example of an acquisition setting receiving unit. The information provider 154 is an example of a providing unit. The synchronization of the setting information performed by the electronic blackboard 2 is an example of a method for communication.

The present application is based on Japanese priority application No. 2015-194990 filed on Sep. 30, 2015, with the Japanese Patent Office, the entire contents of which are hereby incorporated by reference.

### REFERENCE SIGNS LIST

1 information processing system
2 electronic blackboard
3 display
4 electronic pen
20 client unit
90 server unit
150 setting provider
151 communicator
152 setting receiver
153 MD generator
154 information provider
155 memory reader
156 higher-level information setting unit
180 setting acquirer
181 communicator
182 setting receiver
183 setting requester
184 MD comparer
185 memory reader
186 information acquirer
187 MD generator
188 error code display unit
189 lower-level information setting unit
190 update detector

1. A communication system comprising a plurality of information processing apparatuses forming a hierarchic structure having a depth of three or more levels,
wherein each of the plurality of information processing apparatuses includes a setting information storing unit configured to store setting information relating to respective operations,
wherein at least one of the plurality of information processing apparatuses includes a setting receiving unit configured to receive setting information entered to the at least one of the plurality of information processing apparatuses and configured to store the setting information in the setting information storing unit,
wherein at least one of the plurality of information processing apparatuses arranged in any level situated lower in the hierarchic structure than the at least one of the plurality of information processing apparatuses which receives the entered setting information includes a communication information storing unit configured to store communication information for starting communication with one of the plurality of information processing apparatuses arranged in a level immediately above, and an acquiring unit configured to acquire the setting information through the started communication with the one of the plurality of information processing apparatuses in the level immediately above by use of the communication information retrieved from the communication information storing unit and configured to store the acquired setting information in the setting information storing unit, and
wherein the at least one of the plurality of information processing apparatuses arranged in any level situated lower in the hierarchic structure than the at least one of the plurality of information processing apparatuses which receives the entered setting information performs processing of starting the communication with the one of the plurality of information processing apparatuses arranged in the level immediately above, in order to acquire the setting information stored in the setting information storing unit through the started communication.

2. The communication system according to claim 1,
wherein the at least one of the plurality of information processing apparatuses arranged in any level situated lower in the hierarchic structure than the at least one of the plurality of information processing apparatuses which receives the entered setting information further includes a determining unit configured to determine whether the setting information is updated based on information relevant to the setting information acquired from the one of the plurality of information processing apparatuses arranged in the level immediately above, and
wherein the acquiring unit provided on the at least one of the plurality of information processing apparatuses arranged in any level situated lower in the hierarchic structure than the at least one of the plurality of information processing apparatuses which receives the entered setting information acquires the setting information from the one of the plurality of information processing apparatuses arranged in the level immediately above, in response to a determination of the determining unit that the setting information stored in the one of the plurality of information processing apparatuses arranged in the level immediately above is updated.

3. The communication system according to claim 2,
wherein the at least one of the plurality of information processing apparatuses which receives the entered setting information and the at least one of the plurality of information processing apparatuses arranged in any level situated lower in the hierarchic structure than the at least one of the plurality of information processing apparatuses which receives the entered setting information includes a generating unit configured to generate a message digest based on the setting information,
wherein the at least one of the plurality of information processing apparatuses arranged in any level situated lower in the hierarchic structure than the at least one of the plurality of information processing apparatuses which receives the entered setting information includes a message digest acquiring unit configured to acquire the message digest generated in the one of the plurality of information processing apparatuses arranged in the level immediately above,
wherein the determining unit compares the message digest acquired by the message digest acquiring unit and the message digest generated by the generating unit provided on the at least one of the plurality of information processing apparatuses arranged in the level situated lower in the hierarchic structure than the at least one of the plurality of information processing apparatuses which receives the entered setting information, and
wherein the acquiring unit provided on the at least one of the plurality of information processing apparatuses arranged in any level situated lower in the hierarchic structure than the at least one of the plurality of information processing apparatuses which receives the entered setting information acquires the setting information from the one of the plurality of information processing apparatuses arranged in the level immediately above, in response to a determination of the determining unit that the message digest acquired by the message digest acquiring unit and the message digest generated by the generating unit provided on the at least one of the plurality of information processing apparatuses arranged in the level situated lower in the hierarchic structure than the at least one of the plurality of information processing apparatuses which receives the entered setting information.

4. The communication system according to claim 1,
wherein the acquiring unit acquires the setting information from the one of the plurality of information processing apparatuses arranged in the level immediately above at a timing common to at least one of the plurality of information processing apparatuses arranged in any level situated lower in the hierarchic structure than the at least one of the plurality of information processing apparatuses which receives the entered setting information, and
wherein the acquiring unit provided on the at least one of the plurality of information processing apparatuses arranged in any level situated lower in the hierarchic structure than the at least one of the plurality of information processing apparatuses which receives the entered setting information acquires the setting information from the one of the plurality of information processing apparatuses arranged in the level immediately above at a timing after the one of the plurality of information processing apparatuses arranged in the level immediately above acquires the setting information.

5. The communication system according to claim 4,
wherein the acquiring unit records a date and time of an acquisition, in response to the acquisition of the setting information from the one of the plurality of information processing apparatuses in the level immediately above, and records a reason for a failure of an acquisition, in response to the failure of the acquisition of the setting information from the one of the plurality of information processing apparatuses in the level immediately above, and
wherein the at least one of the plurality of information processing apparatuses arranged in any level situated lower in the hierarchic structure than the at least one of the plurality of information processing apparatuses which receives the entered setting information includes a display controlling unit configured to display the date and time or the reason for the failure on a display of an external device coupled to the at least one of the plurality of information processing apparatuses arranged in the level situated lower in the hierarchic structure than the at least one of the plurality of information processing apparatuses which receives the entered setting information or a display of the at least one of the plurality of information processing apparatuses arranged in the level situated lower in the hierarchic structure than the at least one of the plurality of information processing apparatuses which receives entered the setting information.

6. The communication system according to claim 1,
wherein the setting information storing unit includes a first region configured to store the setting information acquired by the acquiring unit, and a second region configured to store the setting information received by the setting receiving unit or the setting information sent from the one of the plurality of information processing apparatuses arranged in a level immediately below,
wherein the at least one of the plurality of information processing apparatuses which receives the entered setting information and at least one of the plurality of information processing apparatuses arranged in any level situated higher in the hierarchic structure than the at least one of the plurality of information processing apparatuses which receives the entered setting information includes an update detecting unit configured to detect an update of the setting information stored in the second region, and an upward sending unit configured to send the setting information stored in the second region to the one of the plurality of information processing apparatuses in the level immediately above, in response to a detection of the update detecting unit that the setting information stored in the second region is updated, and
wherein the one of the plurality of information processing apparatuses in the level immediately above, which receives the setting information from the upward sending unit, stores the setting information received from the upward sending unit in the second region of the setting information storing unit.

7. The communication system according to claim 6,
wherein the first region stores the setting information retrieved by each of the plurality of information processing apparatuses for respective operations, and
wherein the at least one of the plurality of the information processing apparatuses which receives the entered setting information and the at least one of the plurality of information processing apparatuses arranged in any level situated higher in the hierarchic structure than the at least one of the plurality of information processing apparatuses which receives the entered setting information updates the setting information stored in the first region with the setting information stored in the second region which is detected by the update detecting unit to be updated.

8. The communication system according to claim 6,
wherein each of the plurality of information processing apparatuses includes an acquisition setting receiving unit configured to receive a setting entered to each of the plurality of information processing apparatuses as to whether to acquire the setting information from the one of the plurality of information processing apparatuses in respective levels immediately above,
wherein, in a case where the acquisition setting receiving unit receives the entered setting not to acquire the setting information, the upward sending unit does not send the setting information to the one of the plurality of information processing apparatuses in the respective levels immediately above in response to a detection of the update detecting unit that the setting information stored in the second region is updated, and
wherein the setting information stored in the first region is updated with the setting information stored in the second region.

9. An information processing apparatus coupled with a first information processing apparatus and a second information processing apparatus, in which the first information processing apparatus receives and stores setting information entered to the first information processing apparatus or stores setting information acquired from another information processing apparatus, the information processing apparatus comprising:
a communication information storing unit configured to store communication information for starting communication with the first information processing apparatus;
an acquiring unit configured to acquire the setting information through the started communication with the first information processing apparatus by use of the communication information retrieved from the communication information storing unit;
a setting information storing unit configured to store the setting information acquired by the acquiring unit; and
a providing unit configured to provide the setting information stored in the setting information storing unit to the second information processing apparatus, in response to a request for the setting information from the second information processing apparatus.

10. A method for communication conducted in a communication system including a plurality of information processing apparatuses forming a hierarchic structure having a depth of three or more levels, in which each of the plurality of information processing apparatuses includes a setting information storing unit configured to store setting information relating to respective operations, the method comprising:
receiving setting information entered to at least one of the plurality of information processing apparatuses that relates and storing the setting information in the setting information storing unit, which are performed by the at least one of the plurality of information processing apparatuses;
acquiring the setting information through communication with one of the plurality of information processing apparatuses in a level immediately above by use of communication information retrieved from a communication information storing unit storing the communication information for starting the communication with the one of the plurality of information processing apparatuses arranged in the level immediately above, and storing the acquired setting information in the setting information storing unit, which are performed by at least one of the plurality of information processing apparatuses arranged in any level situated lower in the hierarchic structure than the at least one of the plurality of information processing apparatuses which receives the entered setting information; and
starting the communication with the one of the plurality of information processing apparatuses arranged in the level immediately above, in order to acquire the setting information stored in the setting information storing unit through the started communication, which is performed by the at least one of the plurality of information processing apparatuses arranged in any level situated lower in the hierarchic structure than the at least one of the plurality of information processing apparatuses which receives the entered setting information.
